(19) United States
(12) Patent Application Publication
(10) Pub. No.: US 2007/0283516 A1
(43) Pub. Date: Dec. 13, 2007

(54) Disposable nonwoven implement

(75) Inventors: Craig Merillat Rasmussen, Loveland, OH (US); Brent William Mason, West Chester, OH (US); David William Schuller, Lebanon, OH (US); Shellie Jean Porter Caudill, Liberty Township, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Iams Company

(21) Appl. No.: 11/788,410

(22) Filed: Apr. 20, 2007

Related U.S. Application Data
(60) Provisional application No. 60/794,701, filed on Apr. 25, 2006.

(51) Int. Cl. A01K 13/00

(52) U.S. Cl. 15/160; 15/104.001

(57) ABSTRACT

A disposable nonwoven implement that is retained on a user's hand during use is provided. The disposable nonwoven implement can be associated with a composition.

### CROSS REFERENCE TO RELATED APPLICATIONS

This application claims the benefit of U.S. Provisional Application No. 60/794,701, filed Apr. 25, 2006.

### FIELD OF THE INVENTION

The present invention relates to a disposable nonwoven implement that is retained on a user's hand during use is provided. The disposable nonwoven implement can be associated with a composition.

### BACKGROUND OF THE INVENTION

Grooming a companion animal is necessary in order to maintain the companion animal's health. Typically, the products used to clean, condition, and treat a companion animal must meet certain criteria. These criteria include cleansing effectiveness, skin feel, mildness to skin, hair, and ocular mucosae, pleasant smell, and lather volume. Ideal companion animal cleansers should gently cleanse the skin or hair, causes little or no irritation, and should not leave the skin or hair overly dry after use.

It is highly desirable to deliver cleansing, conditioning and treatment benefits from a disposable substrate. Disposable products are convenient because they obviate the need to carry or store cumbersome bottles, jars, tubes, and other forms of clutter associated with cleansing products and other products capable of providing therapeutic or aesthetic benefits. Disposable products are also a more sanitary alternative to the use of a sponge, washcloth, or other cleansing/conditioning implement intended for extensive reuse, because such implements must be cleaned following use, can develop bacterial growth, unpleasant odors, and other undesirable characteristics related to repeated use.

Additionally, companion animals tend to squirm and attempt to escape during the cleansing, treatment and conditioning process which results in inefficient use of the cleansing/conditioning product and/or contact with the companion animal. Additionally, with a companion animal the bathing process is normally highly unpleasant for the companion animal and results in increased anxiety, nervousness and as a result of this unpleasant experience for the companion animal owner.

However, while disposable articles, such as disposable washcloths or disposable sheets, are desirable they have their own problems. Retention on the hand of a user of such disposable washcloths or sheets, especially during vigorous scrubbing, is one such problem. If the washcloth or sheet is prone to fall during use, the user is more concerned with retaining the disposable washcloths or disposable sheets in their hand instead of actually using the article to wash the companion animal which is exacerbated by a squirming companion animal.

The need remains for a disposable implement which is easy to use, suitable for use by consumers, able to cleanse, treat and condition effectively, mild to the skin, hair, and ocular mucosae of the companion animal, provide a pleasant smell, and ideal lather volume. Furthermore, the need remains for a disposable implement which is retained on a user's hand such that the consumer can focus on the task at hand, namely washing, cleaning, treating, and conditioning and at the same time provide a soothing contact between the user and the companion animal without having to be concerned with retaining the disposable implement on their hand.

### SUMMARY OF THE INVENTION

The present invention relates to a disposable nonwoven implement, said implement comprising: (a) a first and second nonwoven sheet members, said first and second nonwoven members being secured to each other along at least a portion of a periphery of said nonwoven sheet members to form an interior volume between said nonwoven sheet members and an opening to receive a user's hand; and (b) a composition associated with at least one of said first and second nonwoven sheet members.

The present invention further relates to a disposable nonwoven implement, said implement comprising: (a) a first and second nonwoven sheet members, said first and second nonwoven members being secured to each other along at least a portion of a periphery of said nonwoven sheet members to form an interior volume between said nonwoven sheet members and an opening to receive a user's hand; (b) a composition associated with at least one of said first and second nonwoven sheet members; and wherein said implement is a glove.

The present invention further relates to a disposable nonwoven implement, said implement comprising: (a) a first and second nonwoven sheet members; wherein at least one of said members is a multi-layer nonwoven sheet member; wherein said first and second nonwoven members are secured to each other along at least a portion of a periphery of said nonwoven sheet members to form an interior volume between said nonwoven sheet members and an opening to receive said user's hand; and (b) a personal care composition associated with at least one of said first and second nonwoven sheet members.

The present invention further relates to a disposable nonwoven implement, said implement comprising: (a) a first and second nonwoven sheet members, said first and second nonwoven members being secured to each other along at least a portion of a periphery of said nonwoven sheet members to form an interior volume between said nonwoven sheet members and an opening to receive a user's hand; (b) a composition associated with at least one of said first and second nonwoven sheet members; and wherein said implement further comprises a third nonwoven sheet member.

The present invention further relates methods for cleansing, conditioning, and treating the skin or hair and similar keratin-containing surfaces of the companion animal, primarily skin and hair using the disposable implement described herein.

The present invention further relates to a kit for a companion animal implement comprising: (a) a composition; and (b) a disposable nonwoven implement.

### BRIEF DESCRIPTION OF THE DRAWINGS

FIG. 1 is a perspective view of a disposable nonwoven implement of the present invention.

FIG. 2 is a perspective view of a disposable nonwoven implement of the present invention.

FIG. 3 is a perspective view of a disposable nonwoven implement of the present invention.

FIG. 4 is a perspective view of a disposable nonwoven implement of the present invention.

FIG. 5 is a perspective view of a disposable nonwoven implement of the present invention.

FIG. 6 is a perspective view of a disposable nonwoven implement of the present invention.

FIG. 7 is a perspective view of a disposable nonwoven implement of the present invention.

FIG. 8 is a perspective view of a disposable nonwoven implement of the present invention.

FIG. 9 is a perspective view of a disposable nonwoven implement of the present invention.

FIG. 10 is a perspective view of a disposable nonwoven implement of the present invention.

FIG. 11 is a side view of a disposable nonwoven implement of the present invention.

FIG. 12 is a perspective view of a disposable nonwoven implement of the present invention.

FIG. 13 is a perspective view of a disposable nonwoven implement of the present invention.

FIG. 14 is a perspective view of a disposable nonwoven implement of the present invention.

FIG. 15 is a perspective view of a disposable nonwoven implement of the present invention.

FIG. 16 is a perspective view of a disposable nonwoven implement of the present invention.

FIG. 17 is a front view of a disposable nonwoven implement of the present invention.

FIG. 18 is a back view of the disposable nonwoven implement of FIG. 17.

FIG. 19 is a front view of a disposable nonwoven implement of the present invention.

FIG. 20 is a back view of the disposable nonwoven implement of FIG. 19.

FIG. 21 is a front view of a disposable nonwoven implement of the present invention.

FIG. 22 is a back view of the disposable nonwoven implement of FIG. 21.

FIG. 23 is a front view of a disposable nonwoven implement of the present invention.

FIG. 24 is a back view of the disposable nonwoven implement of FIG. 23.

FIG. 25 is a front view of a disposable nonwoven implement of the present invention.

FIG. 26 is a back view of the disposable nonwoven implement of FIG. 25.

FIG. 27. is an exploded perspective view of disposable nonwoven implement of the present invention having four nonwoven sheet members.

FIG. 28. is an exploded perspective view of disposable nonwoven implement of the present invention having three nonwoven sheet members.

FIG. 29. is an exploded perspective view of disposable nonwoven implement of the present invention having three nonwoven sheet members.

FIG. 30 is a front view of a disposable nonwoven implement of the present invention.

### DETAILED DESCRIPTION OF THE INVENTION

The instant disposable nonwoven implement, and methods of the present invention, are suitable for use by a user, in cleansing, treating, and conditioning a companion animal. Due to the ease and simple method of use a user is able to clean, treat, or condition their companion animal, with the instant invention.

As used herein, the term “companion animal” means an animal including (for example) dogs, cats, horses, rabbits, guinea pig, hamster, gerbil, ferret, zoo mammals and the like. Dogs, rabbits, horses and cats are particularly preferred.

By “composition associated with nonwoven sheet member(s)”, as used herein, means compositions that are applied to or inside of the individual fibers prior to forming the implement, permeated into the implement, coated onto, within or adjacent to the exposed surfaces of the implement, within or adjacent to the interior surfaces of the implement. The composition can be releasably associated with the implement.

The term “disposable” is used herein in its ordinary sense to mean an article that is disposed or discarded after a limited number of usage events, preferably less than 5, more preferably less than about 3, and even more preferably less than about 2 entire usage events.

The term “fluid” is used herein to mean “fluids” selected from the group consisting of water, mono- and polyhydric alcohols (glycerin, propylene glycol, ethanol, isopropanol, etc.), hydrocarbon oils such as mineral oil, silicone fluids, also triglyceride oils, also fluid resins such as silicone MQ resins, esters and ethers of hydrocarbons, alcohols, perfume, fragrance oils, natural oils such as terpenes, various tree and plant oils, as well as mixtures of the above and can contain other components or compositions dissolved or dispersed within them, or in addition to them.

The phrase “substantially free of” as used herein, means that the composition comprises less than about 3%, preferably less than about 1%, more preferably less than about 0.5%, even more preferably less than about 0.25%, and still more preferably less than about 0.1%, even still more preferably less than 0.01% by weight of the composition, of the stated ingredient.

The term “activated,” as used herein, means that implements produce a benefit or are “activated” by producing them with a fluid and then further subjecting the article to mechanical forces, such as rubbing.

The term “substantially dry,” as used herein, means that prior to use the implement is substantially free of fluid and generally feels dry to the touch. As used herein, “substantially dry” means that the implement of the present invention exhibit a Moisture Retention of less than about 0.95 gms, preferably less than about 0.75 gms, preferably less than about 0.5 gms, preferably less than about 0.25 gms, preferably less than about 0.15 gms, and preferably less than about 0.1 gms. The determination of the Moisture Retention is hereafter. Thus, the “substantially dry” implement of the present invention will generally comprise less than about 20% by weight of the dry implement of fluid, preferably from 4% to about 20% by weight of the dry implement of fluid, and more preferably from about 4% to about 16% by weight of the dry implement of fluid.

The term “moist,” as used herein, means that prior to use the implement can feel relatively dry to the touch and still contain high fluid content. Thus, the “moist” implements of the present invention will generally comprise from about 20% to about 40% by weight of the dry implement of fluid.

The term “wet” means that prior to use the implement can feel wet to the touch and contain high fluid content. The weight percent of fluid in the “wet” implement is based on the total weight of the composition. The weight is expressed as a by weight of fluid. Thus, the “wet” implements of the present invention will generally comprise from about greater than 40% by weight of the dry implement of fluid, preferably from 40% to about 95% by weight of the dry implement of fluid, and more preferably from about 50% to about 80% by weight of the dry implement of fluid.

Disposable Nonwoven Implement

The disposable nonwoven implement can be used by individuals primarily for cleansing, conditioning, and, or treatment of skin, hair or other similar keratin-containing surfaces including skin, hair, paws, ears and nails of a companion animal. The implement is selected from the group consisting of a mitt, a mitten, a glove, and combinations thereof. The implement can be substantially dry, moist or wet.

The disposable nonwoven implement of the present invention comprise nonwoven sheet members. The implement comprises at least two nonwoven sheet members. The nonwoven sheet members are secured to each other along at least a portion of the periphery of the nonwoven sheet members. The securing of the nonwoven sheet members form an interior volume between the sheet members so that there is an opening to receive the user's hand. Additionally, the implement comprises at least one sleeve, at least two sleeves, at least three sleeves, preferably at least four sleeves, at least five sleeves, at least 6 sleeves for insertably receiving at least one finger of the user's hand, at least two fingers, at least three fingers, at least four fingers, at least five fingers and one thumb of the user's hand. Additionally, the sleeves can be connected to another with a webbing located between each of the sleeves.

In one preferred embodiment of the disposable nonwoven implement, the implement further comprises a wrist portion. The wrist portion can optionally comprise a closure means. The closure means includes Velcro®, buckle, tape, button, elastic, ties, snaps and combinations thereof. Additionally the wrist portion can comprise a tab which can assist the user in placing the implement on the hand of the user or assist the user in removing the implement from the hand of the user.

In another preferred embodiment, at least one of the nonwoven sheet members of the disposable nonwoven implement can be a multi-layer nonwoven sheet member. The multi-layer nonwoven sheet members can comprise a batting layer.

In another embodiment the disposable nonwoven implement has a composition associated with the implement and/or at least one sheet member.

Nonwoven Sheet Members

The nonwoven sheet members tend to enhance cleansing, treating and conditioning. The nonwoven sheet members can have the same or differing textures such as a soft texture, exfoliating texture or combinations thereof on each side of the sheet members. Additionally, the nonwoven sheet member can aid in the fit of the glove. Preferably, nonwoven sheet members comprise raised elements that can cover the entire exterior surface of a nonwoven sheet member or specific exterior regions of the nonwoven sheet member. The exterior regions can include but not limited to the palm region of the implement, the sleeve region of the implement, the wrist region of the implement, and combinations thereof. The nonwoven sheet members may act as an efficient lathering and exfoliating implement.

Additionally, at least one of the nonwoven sheet members can comprise material for collecting companion animal hair. The material is located on at least one exterior surface of at least one nonwoven sheet member. The material can be a bristle, a single protrusion or any collection of suitable protrusions from the nonwoven that promote removal of loose companion animal hair. The material can remove loose hair, debris such as dirt and dead skin, by physical entanglement with the loose hair and debris. Adhesives applied to the material can assist collection of hair debris, as well as contain the removed hair and debris for disposal with the implement. Materials or coatings that have a high friction coefficient when interacting with hair can also be used to remove hair and debris. For example, soft natural rubber can aid in removing animal hair and debris when used to clean companion animal hair.

By physically coming into contact with the skin or hair, the nonwoven sheet members significantly aids in cleansing and removal of dirt, dead skin, loose hair, and other debris.

Additionally, at least one of the nonwoven sheet members can comprise different colored portions on the surface of at least one nonwoven sheet member. For example, white could identify the portion of the glove intended to be used for cleaning.

The first and second nonwoven sheet members comprise fibers. The nonwoven sheet members may comprise a variety of both natural and synthetic fibers or materials. As used herein, “natural fibers” are those derived from plants, animals, insects or byproducts of plants, animals, and insects. The conventional base starting material is preferably a fibrous web comprising any of the common synthetic or natural textile-length fibers, or combinations thereof. The fiber is selected from the group consisting of monocomponent fibers, multicomponent fibers, multiconstituent fibers, capillary channel fibers, hollow fibers, shaped or lobed fibers and combinations thereof.

Nonlimiting examples of natural materials useful in the present invention include, but are not limited to, silk fibers, keratin fibers and cellulosic fibers. Nonlimiting examples of keratin fibers include those selected from the group consisting of wool fibers, camel hair fibers, and the like. Nonlimiting examples of cellulosic fibers include those selected from the group consisting of wood pulp fibers, cotton fibers, hemp fibers, jute fibers, rayon fibers, flax fibers, and combinations thereof. Cellulosic fiber materials are preferred in the present invention. Cellulosic fiber materials that can be used in the present invention include those such as paper, rayon and Tencile™. Nonlimiting examples of synthetic materials useful in the present invention include those selected from the group consisting of acetate fibers, acrylic fibers, cellulose ester fibers, modacrylic fibers, polyamide fibers, polyester fibers, polyolefin fibers, polyvinyl alcohol fibers, rayon fibers, Tencel™ fibers, polyethylene foam, polyurethane foam, formed films, films, and combinations thereof. Examples of suitable synthetic materials include acrylics such as Acrilan™, Creslan™, and the acrylonitrile-based fiber, Orlon™; cellulose ester fibers such as cellulose acetate, Arnel™, and Acele™; polyamides such as nylons (e.g., nylon 6, nylon 66, nylon 610, and the like); polyesters such as Fortrel™, Kodel™, and the polyethylene terephthalate fiber, polybutylene terephthalate fiber, Dacron™; polyolefins such as polypropylene, polyethylene; polyvinyl acetate fibers; polyurethane foams and combinations thereof. These and other suitable fibers and the nonwovens prepared there from are generally described in Riedel, “Nonwoven Bonding Methods and Materials,” Nonwoven World (1987); The Encyclopedia Americana, vol. 11, pp. 147-153, and vol. 26, pp. 566-581 (1984); U.S. Pat. No. 4,891,227, to Thaman et al., issued Jan. 2, 1990; and U.S. Pat. No. 4,891,228. As used herein, “nonwoven” means that the layer comprises fibers which are not woven into a fabric but rather are formed into a sheet, mat, or pad layer. The fibers can either be random (i.e., randomly aligned) or they can be carded (i.e., combed to be oriented in primarily one direction). Nonwoven sheet members made from synthetic materials useful in the present invention can be obtained from a wide variety of commercial sources.

More preferred synthetic fibers for the nonwoven sheet members are solid staple polyester fibers, which comprise polyethylene terephthalate homopolymers. Suitable synthetic materials may include solid single component and multicomponent synthetic fibers, i.e., more than one type of material making up the fibers. The synthetic fibers may comprise bicomponent or dual component fibers. Such bicomponent fibers may have a core and a sheath configuration or a side-by-side configuration. In either instance, the nonwoven sheet members may comprise either a combination of fibers comprising the above-listed materials or fibers which themselves comprise a combination of the above-listed materials.

For the core-sheath fibers, preferably, the cores comprise materials selected from the group consisting of polyesters, polyolefins having a T_{g} or melting point of at least about 10° C. higher than the sheath material, and combinations thereof. Conversely, the sheaths of the bicomponent fibers preferably comprise materials selected from the group consisting of polyolefins having a T_{g} or melting point of at least about 10° C. lower than the core material, polyesters polyolefins having a T_{g} or melting point of at least about 10° C. lower than the core material, and combinations thereof.

In any instance, side-by side configuration or core-sheath configuration, the fibers of the nonwoven sheet members may exhibit a helical or spiral configuration, particularly the bicomponent type fibers.

A preferred synthetic material for scouring nonwoven sheet members may comprise nylon fibers. A more preferred synthetic material comprises nylon fibers formed into a scrim layer having additional nylon fibers bonded thereto such that the additional fibers form arcs on the scrim layer.

Natural material nonwovens useful in the present invention may be obtained from a wide variety of commercial sources. Nonlimiting examples of suitable commercially available paper layers useful herein include Airtex®, an embossed airlaid cellulosic layer having a base weight of about 71 gsy, available from James River, Green Bay, Wis.; and Walkisoft®, an embossed airlaid cellulosic having a base weight of about 75 gsy, available from Walkisoft U.S.A., Mount Holly, N.C.

Additional suitable nonwoven sheet members include, but are not limited to, those disclosed in U.S. Pat. No. 4,447,294, issued to Osborn on May 8, 1984; U.S. Pat. No. 4,603,176 issued to Bjorkquist on Jul. 29, 1986; U.S. Pat. No. 4,981,557 issued to Bjorkquist on Jan. 1, 1991; U.S. Pat. No. 5,085,736 issued to Bjorkquist on Feb. 4, 1992; U.S. Pat. No. 5,138,002 issued to Bjorkquist on Aug. 8, 1992; U.S. Pat. No. 5,262,007 issued to Phan et al. on Nov. 16, 1993; U.S. Pat. No. 5,264,082, issued to Phan et al. on Nov. 23, 1993; U.S. Pat. No. 4,637,859 issued to Trokhan on Jan. 20, 1987; U.S. Pat. No. 4,529,480, issued to Trokhan on Jul. 16, 1985; U.S. Pat. No. 4,687,153 issued to McNeil on Aug.18, 1987; U.S. Pat. No. 5,223,096, issued to Phan et al. on Jun. 29, 1993 and U.S. Pat. No. 5,679,222, issued to Rasch et al. on Oct. 21, 1997.

Additional suitable materials include, but are not limited to, formed films and composite materials, e.g., multiply materials containing formed films. Preferably, such formed films comprise plastics which tend to be soft to the skin. Suitable soft plastic formed films include, but are not limited to, polyolefins such as low density polyethylenes (LDPE). Additional formed films include microapertured 100 mesh film supplied by Tredegar, Inc., Terre Haute, Ind., USA 47808. Apertures can be formed in a film by any means such as by drawing a vacuum across the film; by forcing fluid such as water through the film while the film is supported in a fine screen such as a 100 mesh screen; by mechanical means such as punching, tearing, stretching; using energy such as heat or light. As used herein, “apertured” means that the layer includes well-defined openings. Well-defined openings are typically surrounded by well-defined land areas. Also, as used herein, “apertures” encompasses holes, perforations, cavities, and the like. The well-defined opening can be impermeable (as in a film, which would be a formed film or a perforated film, e.g.), or permeable. As used herein, “microapertured” generally refers to layers containing well-defined microscopic apertures (i.e., those not readily visible to the naked eye having 20/20 vision).

Methods of making nonwovens are well known in the art. Generally, these nonwovens can be made by air-laying, water-laying, meltblowing, coforming, spunbonding, or carding processes in which the fibers or filaments are first cut to desired lengths from long strands, passed into a water or air stream, and then deposited onto a screen through which the fiber-laden air or water is passed. The resulting layer, regardless of its method of production or composition, is then subjected to at least one of several types of bonding operations to anchor the individual fibers together to form a self-sustaining implement. In the present invention the nonwoven sheet members can be prepared by a variety of processes including, but not limited to, meltblowing, spunbonding, air-entanglement, hydroentanglement, thermal bonding, selective mechanical deformation as described in U.S. application Ser. No. 10/737,640 filed on Dec. 16, 2003 and combinations of these processes.

The nonwoven sheet members can also be secured, by either chemical or physical means around at least a portion of the periphery of the nonwoven sheet members.

Secured by chemical means can be accomplished by causing the periphery of the nonwoven sheet members to join when they are chemically similar, in which case adhesion may be assisted by heat, pressure, solvent, adhesives or combinations thereof. Heat and pressure can be provided by various processing techniques which are well known. Securing by physical means can be accomplished by needle punching, ultrasonic bonding, high pressure bonding, thermal bonding, crimping, stitching, or combinations thereof. The securing by physical means involves the interpenetration of at least a portion of the periphery one nonwoven sheet member into and around at least a portion of the periphery of a second nonwoven sheet member.

Batting Layer

In an embodiment of the present invention at least one of the nonwoven sheet members can comprise a multi-layered nonwoven sheet member. The multi-layered sheet member can comprise a batting layer. The batting layer preferably comprises synthetic materials. As used herein, “synthetic” means that the materials are obtained primarily from various man-made materials or from natural materials that have been further altered. Suitable synthetic materials include, but are not limited to, acetate fibers, acrylic fibers, cellulose ester fibers, modacrylic fibers, polyamide fibers, polyester fibers, polyolefin fibers, polyvinyl alcohol fibers, rayon fibers, polyethylene foam, polyurethane foam, and combinations thereof. Preferred synthetic materials, particularly fibers, may be selected from the group consisting of nylon fibers, rayon fibers, Tencel™ fibers, polyolefin fibers, polyester fibers, and combinations thereof. Preferred polyolefin fibers are fibers selected from the group consisting of polyethylene, polypropylene, polybutylene, polypentene, and combinations and copolymers thereof. More preferred polyolefin fibers are fibers selected from the group consisting of polyethylene, polypropylene, and combinations and copolymers thereof. Preferred polyester fibers are fibers selected from the group consisting of polyethylene, terephthalate, polybutylene terephthalate, polycyclohexylenedimethylene terephthalate, and combinations and copolymers thereof. More preferred polyester fibers are fibers selected from the group consisting of polyethylene terephthalate, polybutylene terephthalate, and combinations and copolymers thereof. Most preferred synthetic fibers comprise solid staple polyester fibers that comprise polyethylene terephthalate homopolymers. Suitable synthetic materials may include solid single component (i.e., chemically homogeneous) fibers, multiconstituent fibers (i.e., more than one type of material making up each fiber), and multicomponent fibers (i.e., synthetic fibers which comprise two or more distinct filament types which are somehow intertwined to produce a larger fiber), and combinations thereof. Preferred fibers include bicomponent fibers, multiconstituent fibers, and combinations thereof. Such bicomponent fibers may have a core-sheath configuration or a side-by-side configuration. In either instance, the batting layer may comprise either a combination of fibers comprising the above-listed materials or fibers which themselves comprise a combination of the above-listed materials.

The batting layer may also comprise natural fibers. Suitable natural fibers are described above in the nonwoven sheet members section.

Furthermore, the fibers of the batting layer preferably have an average thickness of from about 0.5 microns to about 150 microns. More preferably, the average thickness of the fibers are from about 5 microns to about 75 microns. In an even more preferred embodiment, the average thickness of the fibers are from about 8 microns to about 40 microns. Furthermore, the fibers of the batting layer may be of varying sizes, i.e., the fibers of the batting layer may comprise fibers having different average thicknesses. Also, the cross section of the fibers can be round, flat, oval, elliptical or otherwise shaped.

In another embodiment, the batting layer of the present invention may comprise a composite material, i.e., a material having one or more plies of the same or different suitable materials merely superimposed physically, joined together continuously (e.g., laminated, etc.) or in a discontinuous pattern, or by bonding at the external edges (or periphery) of the layer and/or at discrete loci. The term composite means that at least one layer did not exist as a distinct layer apart from the article, said layer being formed during a processing step involving mixing of two or more components or compositions to form a heterogeneous mixture. The term laminate means at least one layer existed apart from the implement and is combined to form an implement by a lamination process, including thermal (including ultrasonic) and adhesive bonding lamination processes. For example, the batting layer may further comprise composite materials selected from the group consisting of fibrous nonwovens, sponges, foams, reticulated foams, polymeric nets, scrims, vacuum-formed laminates, formed films and formed film composite materials. It is preferred that the batting layer comprises a formed film composite material comprising at least one formed film and at least one nonwoven wherein the layer is vacuum formed. A suitable formed film composite material includes, but is not limited to a vacuum laminated composite formed film material formed by combining a carded polypropylene nonwoven having a basis weight of 30 gsm with a formed film.

Additional Nonwoven Sheet Members

In another embodiment, the implement of the present invention may comprise one or more additional nonwoven sheet members which one having ordinary skill in the art would recognize as separate and distinct from the first and second nonwoven sheet members yet which are attached to these nonwoven sheet members at some point forming a multi-layered implement. The additional nonwoven sheet members are suitable for enhancing the overall cleansing, conditioning, and treatment of the surface to be cleansed, conditioned and/or therapeutically treated. Also, the additional nonwoven sheet members are suitable for enhancing the conditioning, treating or cleansing of the disposable nonwoven implement which contacts the surface to be cleansed, conditioned and/or therapeutically treated.

The nonwoven sheet members can comprise raised elements that can cover the entire exterior surface of a nonwoven sheet member, or specific exterior regions of a nonwoven sheet member. The exterior regions can include but not limited to the palm region of the implement, the sleeve region of the implement, the wrist region of the implement, and combinations thereof. The nonwoven sheet members may act as an efficient lathering and exfoliating implement.

Additionally, at least one of the nonwoven sheet members can comprise material for collecting companion animal hair. The material is located on at least one exterior surface of at least one nonwoven sheet member. The material can be a bristle, a single protrusion or any collection of suitable protrusions from the nonwoven that promote removal of loose companion animal hair. The material can remove loose hair, debris such as dirt and dead skin, by physical entanglement with the loose hair and debris. Adhesives applied to the material can assist collection of hair debris, as well as contain the removed hair and debris for disposal with the implement. Materials or coatings that have a high friction coefficient when interacting with hair can also be used to remove hair and debris. For example, soft natural rubber can aid in removing animal hair and debris when used to clean companion animal hair.

In any instance, these additional nonwoven sheet members may also be referred to as consecutively numbered nonwoven sheet members in addition to the two essential nonwoven sheet members of the present invention, e.g., third nonwoven sheet member, fourth nonwoven sheet member, etc. When additional nonwoven sheet member are present, the first and second nonwoven sheet members will always be the outer most nonwoven sheet members of the implements. Suitable additional nonwoven sheet members may comprise those materials and characteristics which are disclosed above as suitable for the first and second nonwoven sheet members and multi-layered sheet members.

### Raised Elements

The implement of the present invention can comprise raised elements on at least one nonwoven sheet member and/or comprises raised elements which are located between the nonwoven sheet members of an implement comprising multi-layered nonwoven sheet members. The raised elements can be detected as being present when the user views the exterior of the implement. The raised elements may be discrete.

In a preferred embodiment, the implement comprises a first nonwoven sheet member, a second nonwoven sheet member, a third nonwoven sheet member where the raised elements are located between the first and third nonwoven sheet member. In another preferred embodiment, the implement comprises a first sheet member, a second sheet member, and a third sheet member where the raised elements are located on the exterior surface of the first sheet member. In another preferred embodiment, the implement comprises a first nonwoven sheet member, a second nonwoven sheet member, a third nonwoven sheet member, and a fourth nonwoven sheet member where the raised regions are located between the first and third nonwoven sheet member.

In another preferred embodiment, the implement comprises a first nonwoven sheet member, a second nonwoven sheet member, a third nonwoven sheet member, and a fourth nonwoven sheet member where the raised regions are located between the third and fourth nonwoven sheet member.

The raised elements can be made of any suitable material for providing massaging, cleansing, and treating properties. Suitable materials include, but are not limited to, nonwoven material, hot melt coatings, natural rubber, synthetic rubber, polyolefins, such as polyethylene and polypropylene, ethylene vinyl acetate, and thermoplastic elastomers. Colorants or pigments may be combined with the materials to provide regions on the implement which highlight the raised elements.

Suitable hot melt coatings for generating raised elements include HL-7471 W from H. B. Fuller Co., St. Paul, Minn., and REXTAC amorphous polyolefins, available through Huntsman Chemical. For example, hot melt coatings containing from about 15% to about 100% olefin polymer or a block copolymer, from about 0% to about 60% tackifying resin, and from about 0% to about 50% wax may be useful. Suitable olefin polymers include polymers: a) wherein the olefin polymer is a homopolymer of ethylene, propylene, n-butene, butylene or isobutylene, with a melt flow index from 0.5 to 2500, such as Ateva™, polymers from AT plastics; Escorene.®™, and Vistanex.®™, polymers from Exxon Chemical, Duraflex.®™., polymers from Shell Chemical, Epolene.®™., polymers from Eastman Chemical, and Vestoplast.®™., polymers from Creanova; b) wherein the olefin polymer is a copolymer of ethylene and a co-monomer, such as vinyl acetate, acrylic acid, methacrylic acid, ethyl acrylate, methyl acrylate, n-butyl acrylate vinyl silane or maleic anhydride, such as Ateva.™, polymers from AT plastics, Elvax.®™., polymers from DuPont, Escorene.®™., and Optema.®™., polymers from Exxon Chemical, and Primacor.®™., polymers from Dow Chemical; and c) wherein the olefin polymer is a terpolymer of ethylene and co-monomers, such as vinyl acetate, acrylic acid, methacrylic acid, ethyl acrylate, methyl acrylate, n-butyl acrylate vinyl silane or maleic anhydride, such as Ateva.™, polymers from AT plastics, Nucrel®™., polymers from DuPont, and Escor.®™, polymers from Exxon Chemical.

Suitable block copolymers include block copolymers having a linear or a radial structure such that the structure (A-B).sub.x where A is consists essentially of a polyvinylarene block, and B consists essentially of poly(monoalkenyl) block, and x denotes the number of polymeric arms, where x is greater than or equal to one are also useful. Block B may be selected from conjugated diene elastomers such as polybutadiene or polyisoprene and hydrogenated elastomers such as ethylene-butylene or ethylene-propylene. Suitable examples of these types of polymers include Kraton.®™. elastomers from Shell Chemical Company, Vector.®™. elastomers from Dexco, Solprene.®™. elastomers from Enichem Elastomers and Stereon.®™. from elastomers Firestone Tire & Rubber Co. When the hot melt coatings contain block copolymers, it is preferable for the coating to contain from about 15% to about 50% block copolymer.

Suitable tackifying resins include any compatible resin or mixture thereof selected from the group consisting of a) natural and modified rosins; b) glycerol and pentaerythritol esters of natural and modified rosins; c) polyterpene resins; d) copolymers and terpolymers of natural terpenes; e) phenolic modified terpene resins and the hydrogenated derivatives thereof, f) aliphatic petroleum resins and the hydrogenated derivatives thereof; g) aromatic petroleum resin and the hydrogenated derivatives thereof; and h) aliphatic/aromatic petroleum resins and the hydrogenated derivatives thereof, such as Foral.®™. resin, Staybelite.®™. resin, Poly-pale.®™. resin, Permalyn.®™. resin, Pentalyn.®™. resin, Adtac.®™. resin, Piccopale.®™. resin, Piccotac.®™. resin, Hercotac.®™. resin, Regalrez.®™. resin, and Piccolyte.®™. resin from Hercules, Escorez.®™. resin from Exxon Chemical, Wingtack.®™. resin from Goodyear Tire & Rubber Co., Arkon.®™. resin from Arakawa Chemicals, Zonatac.®™. resin, Zonarez.®™. resin and Zonester.®™. resin from Arizona Chemical and Nevtac.®™. resin from Neville Chemical Company.

Suitable waxes include, but are not limited to, paraffins, Fischer-tropsh, and microcrystalline waxes, and combinations thereof. Suitable microcrystalline waxes include, but are not limited to, BE SQUARE 175 microwax, available from Bareco Division, Petrolite Corporation, and M-5165 from Moore & Munger, Shelton, Conn.

Suitable polyethylene waxes include, but are not limited to, H-101 from Exxon Chemical, Houston, Tex. Suitable Fischer-Tropsch waxes include, but are not limited to, Paraflint Wax from Schumann Sasol, Hamburg, Germany.

Additionally, the raised regions may be formed by using a printed pattern using a liquid paint/ink that expands and hardens during curing to result in raised regions. Examples include Aqua-Puff Ink made by Polytex.

The raised elements may be applied onto the nonwoven sheet member by any means known in the art, such as control coating, control fiberization, pattern coating, gravure coating, rotary screen printing, and spray coating or placement of discrete pre-fabricated solid or hollow elements onto the nonwoven sheet member. Equipment for coating the nonwoven sheet member is commercially available. One example is the DYNAFIBER, available through Nordson Company. Another example is the ITW, available through Omega Company. When applying raised elements through a melt process, the time it takes to cool the applied coating affects the height of the raised elements. If the coating is not cooled quickly enough, the coating may penetrate the substrate to the extent that no raised element is formed. To overcome this problem, an air knife that utilizes air, which may be chilled, may be utilized to quickly cool the applied coating and prevent tailing. The angle of contact between the air and the applied coating may also affect the height of the raised elements. The air typically contacts the coating at an angle of from about 10 to about 80.degree.

Depending on the raised element material, a skin-layer may be formed on the molten or liquid raised element that stabilizes the shape of the raised element after it is formed and before it completely cools or solidifies. This skin layer may form naturally for some materials or can be promoted to form by cooling with directed air flows or by the spray application of a liquid to either cool the surface of the raised element and promote the skin layer to form or by interacting chemically by reacting to promote the formation of a skin layer or cause the applied raised element to rapidly solidify. Other methods for promoting the solidification of the raised elements can be used. Ultraviolet light, for instance, can promote certain chemical reactions that lead to solidification via chemical crosslinking of liquid or viscous materials. Heat can also be used to solidify certain liquid or viscous materials by activating or promoting chemical reactions. For example, heating natural rubber during vulcanization and heating certain epoxies during curing promotes chemical reactions that cross-link and solidify these liquid or viscous materials. Heat for solidifying the raised element material can be applied by many means or combinations thereof including common physical contact or heat conduction, by using a fluid or gas, moved across a material as in convection, and by electromagnetic radiant heating, as in infrared lamps and electrical heating elements, radiofrequency induction, or microwave heating. Discrete solid or hollow elements can be applied to the surface of the nonwoven sheet member as parts and secured by any mechanical means such as riveting, by an adhesive, or by simply encapsulating them between two nonwovens and sealing around the perimeter of each element. The material comprising the discrete elements can be any suitable stable material, polypropylene, for example, can be injection molded into solid or hollow spheres and then secured into a suitable array on the nonwoven sheet member with adhesive. Optionally, the array of discrete elements can be further integrated with the implement by covering with another nonwoven sheet member and trapping the bonded array in between the nonwoven sheet members.

Nonwoven materials can be used form the raised elements. This can be done by physically forming a layer or several layers of nonwovens into the desired raised elements either by forming the raised elements and permanently compressing the surrounding area to maximize the height of the raised elements, or by forming the raised element and leaving the surrounding area unmodified, or by only compressing the surrounding area of a thick nonwoven or several layers of nonwovens, leaving selected areas of uncompressed material that comprise the raised elements. a rigid device that approximates the size and shape of the desired raised elements to be formed. There can be a male or positive forming rigid device and there can be a female or negative forming device. When the male and female forming devices are combined, they fit together and the boundary between the two devices defines the dimensions of the raised elements to be formed. Another way to form the raised elements would be to use either male or female rigid device with a resilient forming material, such as rubber, that conforms to the shape of the male or female rigid forming device when applied with sufficient force. Raised elements can then be formed by placing a suitable nonwoven or layers of nonwoven materials between the male and female forming parts, bringing the forming parts together, and applying pressure to force the nonwoven into the desired raised elements shape. Once the nonwoven has been forced into the desired raised element shape, it may require stabilization to maintain its shape once the pressure and forming parts are removed. Essentially, the forming of the raised elements in the nonwoven material can be done with any suitable forming method, such as die molding or vacuum molding. Raised elements formed in the nonwovens can be stabilized in and during the forming operation, for example, by the use of adhesives applied to the nonwoven before forming. In addition, stabilization can occur in the forming operation by friction induced curing or melting and/or pressure induced melting or curing of the nonwoven material, part of the nonwoven, or a component added to the nonwoven to promote stabilization of the formed raised elements. A commonly used nonwoven for molding shapes is a carded nonwoven consisting of two different fiber types. One fiber type is made from polyester and the other fiber type is made from a polyester co-polymer. The polyester co-polymer fibers have a differential melting temperature, where one material's melting temperature is significantly lower than the other. In this case the co-polyester fibers have a lower melting temperature than that of the polyester fibers. Once the fabric is molded into the desired shape, heat and pressure are applied in order to melt the co-polyester fibers into the molded matrix of polyester fibers. Once the heat and pressure are removed, the co-polyester solidifies, rigidly binding the matrix of polyester fibers into the molded shape. Other nonwoven materials can be used in this same manner by differential melting temperature where a component of the nonwoven has a lower melting temperature than the remaining matrix. This can also be done by alternating layers of nonwovens made from materials with different melting points, by using mixtures of fibers with different melting points, or by using fibers made from materials with different melting points, for example, bicomponent or multicomponent round or shaped fibers. The nonwoven can produced by any technology, such as carding, melt spinning, solvent spinning, air-laying, wet-laying, or meltblowing.

The raised elements may be of any shape including, but not limited to, lines, waves, interconnected patterns, circular dots, hexagons, hearts, diamonds, rectangles, stars, triangles and the like. The density, height, and diameter of the raised elements may vary depending on the massaging, cleansing, and/or treating properties desired. Generally, the raised elements may occupy anywhere from about 1 percent to about 99 percent, for example from about 1 to about 80 percent, from about 5 to about 70 percent, from about from about 10 percent to about 75 percent, or from about 20 percent to about 50 percent, of at least one nonwoven sheet member. The height of the raised elements, as measured from the surface of the nonwoven sheet member, should be sufficient to provide cleansing, massaging, and/or treating properties. Generally, the height is at least 0.01 mm above the surface of the nonwoven sheet member.

When the raised elements are discrete, the elements have a diameter sufficient to provide massaging, cleansing, and/or treating properties. Generally, the diameter of the discrete raised elements may range from about 0.01 mm to about 6 mm, from about 0.1 mm to about 5 mm, from about 0.5 mm to about 4 mm, from about 0.8 mm to about 3 mm, from about 1 mm to about 2 mm.

Fluids

The implements of the present invention may comprise volatile and non-volatile fluids selected from the group consisting of water, mono- and polyhydric alcohols (glycerin, propylene glycol, ethanol, isopropanol, etc.), hydrocarbon oils such as mineral oil, silicone fluids, also triglyceride oils, also fluid resins such as silicone MQ resins, esters and ethers of hydrocarbons, alcohols, perfume, fragrance oils, natural oils such as terpenes, various tree and plant oils, as well as mixtures of the above and can contain other components or compositions dissolved or dispersed within them, or in addition to them.

### Compositions

The present invention is for a disposable nonwoven implement used by individuals preferably for cleansing, conditioning and or treatment of skin, hair, nails, ears, paws or other similar keratin-containing surfaces of a companion animal. These disposable nonwoven implements can encompass the use of compositions that are associated with the nonwoven sheet members of the present invention. The compositions of the present invention are selected from the group consisting of cleansing agents, treatment agents, conditioning agents, and mixtures thereof. The present invention can comprise implements that combine two or more different compositions into a single disposable implement. The composition of the present invention can be associated with the disposable nonwoven implement in designated regions of the disposable nonwoven implement.

A. Cleansing Agents

The compositions of the present invention also can comprise one or more cleansing agents that are associated with at least one of the nonwoven sheet members of the present invention. Thus, cleansing agents can be associated with the nonwoven sheet member and or the disposable nonwoven implement. Preferred articles of the present invention are wet, moist, or substantially dry. The cleansing agents can be used on all regions of the companion animal.

The cleansing agent comprises surfactants suitable for application to the companion animal, which when combined with a fluid and mechanically agitated generates a foam or lather sufficient to cause the implement, as a whole, to lather or do not generate a substantial lather depending on the intended use and cleansing agents associated with the implement.

Preferably, these surfactants or combinations of surfactants should be mild, which means that these surfactants provide sufficient cleansing or detersive benefits but do not overly dry the skin or hair, and yet meet the lathering criteria described above. Generally the cleansing agents will comprise no more than about 250 weight percent by weight of the implement of a surfactant. The agents of the present invention comprises no more than about 100 weight percent, no more than about 75 weight percent, and no more than about 50 weight percent by weight of the implement of a surfactant. Generally the cleansing agents will comprise at least 0.1 weight percent by weight of the implement of a surfactant. The agents of the present invention comprises at least 0.6 weight percent, at least 0.75 weight percent, and at least 1 weight percent by weight of the implement of a surfactant.

The surfactant is selected from the group consisting of anionic surfactant, non-ionic surfactant, zwitterionic surfactant, cationic surfactant, soap, and mixtures thereof.

When present, the composition comprises a cleansing agent at concentrations ranging from about 0.1% to about 95%, from about 0.5% to about 95%, from about 1% to about 90%, from about 5% to about 80%, from about 10% to about 70%, and from about 15% to about 60%, by weight of the composition. The cleansing agent comprises the surfactant at concentrations ranging from about 0.1% to about 50%, from about 1% to about 35%, from about 5% to about 30%, from about 8% to about 25%, and from about 10% to about 24%, by weight of the cleansing agent. The preferred pH range of the cleansing agent is from about 4 to about 9, more preferably about 7.

Anionic Surfactants

The composition can comprise an anionic surfactant at concentrations ranging from about 0.1% to about 50%, from about 0.4% to about 30%, from about 0.5% to about 25%, from about 1% to about 20%, from about 2% to about 10%, by weight of the cleansing agent.

Non-limiting examples of anionic surfactants useful in the compositions of the present invention are disclosed in McCutcheon's, Detergents and Emulsifiers, North American edition (1986), published by allured Publishing Corporation; McCutcheon's, Functional Materials, North American Edition (1992); and U.S. Pat. No. 3,929,678, to Laughlin et al., issued Dec. 30, 1975.

A wide variety of anionic surfactants are useful herein. Nonlimiting examples of anionic surfactants include those selected from the group consisting of alkyl and alkyl ether sulfates, sulfated monoglycerides, sulfonated olefins, alkyl aryl sulfonates, primary or secondary alkane sulfonates, alkyl sulfosuccinates, acyl taurates, acyl isethionates, alkyl glycerylether sulfonate, sulfonated methyl esters, sulfonated fatty acids, alkyl phosphates, acyl glutamates, acyl sarcosinates, alkyl sulfoacetates, acylated peptides, alkyl ether carboxylates, acyl lactylates, anionic fluorosurfactants, and combinations thereof.

Non-limiting examples of anionic surfactants include those selected from the group consisting of sarcosinates, sulfates, ethoxylated sulfate, sulfonates, glyceryl sulfonates, isethionates, phosphates, taurates, lactylates, glutamates, soaps, sulfosuccinates, ethoxylated sulfosuccinates , and mixtures thereof.

Other anionic materials useful herein include are fatty acid soaps (i.e., alkali metal salts, e.g., sodium or potassium salts) typically having from a fatty acid having about 8 to about 24 carbon atoms, preferably from about 10 to about 20 carbon atoms. These fatty acids used in making the soaps can be obtained from natural sources such as, for instance, plant or animal-derived glycerides (e.g., palm oil, coconut oil, soybean oil, castor oil, tallow, lard, etc.) Additionally, anionic materials include natural soaps derived from the saponification of vegetable and/or animal fats & oils examples of which include sodium laurate, sodium myristate, palmitate, stearate, tallowate, cocoate. The fatty acids can also be synthetically prepared. Soaps and their preparation are described in detail in U.S. Pat. No. 4,557,853.

Anionic surfactants for use in the composition include alkyl and alkyl ether sulfates. These materials have the respective formulae R1O—SO3M and R1(CH2H4O)x-O—SO3M, wherein R1 is a saturated or unsaturated, branched or unbranched alkyl group from about 8 to about 24 carbon atoms, x is 1 to 10, and M is a water-soluble cation such as ammonium, sodium, potassium, magnesium, triethanolamine, diethanolamine and monoethanolamine. The alkyl sulfates are typically made by the sulfation of monohydric alcohols (having from about 8 to about 24 carbon atoms) using sulfur trioxide or other known sulfation technique. The alkyl ether sulfates are typically made as condensation products of ethylene oxide and monohydric alcohols (having from about 8 to about 24 carbon atoms) and then sulfated. These alcohols can be derived from fats, e.g., coconut oil or tallow, or can be synthetic. Specific examples of alkyl sulfates which may be used in the composition are sodium, ammonium, potassium, magnesium, or TEA salts of lauryl or myristyl sulfate. Examples of alkyl ether sulfates which may be used include ammonium, sodium, magnesium, or TEA laureth-3 sulfate.

Another suitable class of anionic surfactants are the sulfated monoglycerides of the form R1CO—O—CH2-C(OH)H—CH2-O—SO3M, wherein R1 is a saturated or unsaturated, branched or unbranched alkyl group from about 8 to about 24 carbon atoms, and M is a water-soluble cation such as ammonium, sodium, potassium, magnesium, triethanolamine, diethanolamine and monoethanolamine. These are typically made by the reaction of glycerin with fatty acids (having from about 8 to about 24 carbon atoms) to form a monoglyceride and the subsequent sulfation of this monoglyceride with sulfur trioxide. An example of a sulfated monoglyceride is sodium cocomonoglyceride sulfate.

Other suitable anionic surfactants include olefin sulfonates of the form R1SO3M, wherein R1 is a mono-olefin having from about 12 to about 24 carbon atoms, and M is a water-soluble cation such as ammonium, sodium, potassium, magnesium, triethanolamine, diethanolamine and monoethanolamine. These compounds can be produced by the sulfonation of alpha olefins by means of uncomplexed sulfur trioxide, followed by neutralization of the acid reaction mixture in conditions such that any sultones which have been formed in the reaction are hydrolyzed to give the corresponding hydroxyalkanesulfonate. An example of a sulfonated olefin is sodium C14/C16 alpha olefin sulfonate.

Other suitable anionic surfactants are the linear alkylbenzene sulfonates of the form R1-C6H4-SO3M, wherein R1 is a saturated or unsaturated, branched or unbranched alkyl group from about 8 to about 24 carbon atoms, and M is a water-soluble cation such as ammonium, sodium, potassium, magnesium, triethanolamine, diethanolamine and monoethanolamine. These are formed by the sulfonation of linear alkyl benzene with sulfur trioxide. An example of this anionic surfactant is sodium dodecylbenzene sulfonate.

Still other anionic surfactants suitable for this composition include the primary or secondary alkane sulfonates of the form R1SO3M, wherein R1 is a saturated or unsaturated, branched or unbranched alkyl chain from about 8 to about 24 carbon atoms, and M is a water-soluble cation such as ammonium, sodium, potassium, magnesium, triethanolamine, diethanolamine and monoethanolamine. These are commonly formed by the sulfonation of paraffins using sulfur dioxide in the presence of chlorine and ultraviolet light or another known sulfonation method. The sulfonation can occur in either the secondary or primary positions of the alkyl chain. An example of an alkane sulfonate useful herein is alkali metal or ammonium C13-C17 paraffin sulfonates.

Still other suitable anionic surfactants are the alkyl sulfosuccinates, which include disodium N-octadecylsulfosuccinamate; diammonium lauryl sulfosuccinate; tetrasodium N-(1,2-dicarboxyethyl)-N-octadecylsulfosuccinate; diamyl ester of sodium sulfosuccinic acid; dihexyl ester of sodium sulfosuccinic acid; and dioctyl esters of sodium sulfosuccinic acid.

Also useful are taurates which are based on taurine, which is also known as 2-aminoethanesulfonic acid. Examples of taurates include N-alkyltaurines such as the one prepared by reacting dodecylamine with sodium isethionate as detailed in U.S. Pat. No. 2,658,072 which is incorporated herein by reference in its entirety. Other examples based of taurine include the acyl taurines formed by the reaction of n-methyl taurine with fatty acids (having from about 8 to about 24 carbon atoms).

Another class of anionic surfactants suitable for use in the composition is the acyl isethionates. The acyl isethionates typically have the formula R1CO—O—CH2CH2SO3M wherein R1 is a saturated or unsaturated, branched or unbranched alkyl group having from about 10 to about 30 carbon atoms, and M is a cation. These are-typically formed by the reaction of fatty acids (having from about 8 to about 30 carbon atoms) with an alkali metal isethionate. Nonlimiting examples of these acyl isethionates include ammonium cocoyl isethionate, sodium cocoyl isethionate, sodium lauroyl isethionate, and mixtures thereof.

Still other suitable anionic surfactants are the alkylglyceryl ether sulfonates of the form R1-OCH2-C(OH)H—CH2-SO3M, wherein R1 is a saturated or unsaturated, branched or unbranched alkyl group from about 8 to about 24 carbon atoms, and M is a water-soluble cation such as ammonium, sodium, potassium, magnesium, triethanolamine, diethanolamine and monoethanolamine. These can be formed by the reaction of epichlorohydrin and sodium bisulfite with fatty alcohols (having from about 8 to about 24 carbon atoms) or other known methods. One example is sodium cocoglyceryl ether sulfonate.

Other suitable anionic surfactants include the sulfonated fatty acids of the form R1-CH(SO4)-COOH and sulfonated methyl esters of the from R1-CH(SO4)-CO—O—CH3, where R1 is a saturated or unsaturated, branched or unbranched alkyl group from about 8 to about 24 carbon atoms. These can be formed by the sulfonation of fatty acids or alkyl methyl esters (having from about 8 to about 24 carbon atoms) with sulfur trioxide or by another known sulfonation technique. Examples include alpha sulphonated coconut fatty acid and lauryl methyl ester.

Other anionic materials include phosphates such as monoalkyl, dialkyl, and trialkylphosphate salts formed by the reaction of phosphorous pentoxide with monohydric branched or unbranched alcohols having from about 8 to about 24 carbon atoms. These could also be formed by other known phosphation methods. An example from this class of surfactants is sodium mono or dilaurylphosphate.

Other anionic materials include acyl glutamates corresponding to the formula R1CO—N(COOH)—CH2CH2-CO2M wherein R1 is a saturated or unsaturated, branched or unbranched alkyl or alkenyl group of about 8 to about 24 carbon atoms, and M is a water-soluble cation. Nonlimiting examples of which include sodium lauroyl glutamate and sodium cocoyl glutamate.

Other anionic materials include alkanoyl sarcosinates corresponding to the formula R1CON(CH3)-CH2CH2-CO2M wherein R1 is a saturated or unsaturated, branched or unbranched alkyl or alkenyl group of about 10 to about 20 carbon atoms, and M is a water-soluble cation. Nonlimiting examples of which include sodium lauroyl sarcosinate, sodium cocoyl sarcosinate, and ammonium lauroyl sarcosinate.

Other anionic materials include alkyl ether carboxylates corresponding to the formula R1-(OCH2CH2)x-OCH2-CO2M wherein R1 is a saturated or unsaturated, branched or unbranched alkyl or alkenyl group of about 8 to about 24 carbon atoms, x is 1 to 10, and M is a water-soluble cation. Nonlimiting examples of which include sodium laureth carboxylate.

Other anionic materials include acyl lactylates corresponding to the formula R1CO—[O—CH(CH3)-CO]x-CO2M wherein R1 is a saturated or unsaturated, branched or unbranched alkyl or alkenyl group of about 8 to about 24 carbon atoms, x is 3, and M is a water-soluble cation. Nonlimiting examples of which include sodium cocoyl lactylate.

Other anionic materials include the carboxylates, nonlimiting examples of which include sodium lauroyl carboxylate, sodium cocoyl carboxylate, and ammonium lauroyl carboxylate. Anionic flourosurfactants can also be used.

Other anionic materials include phosphates such as monoalkyl, dialkyl, and trialkylphosphate salts. Non-limiting examples of preferred anionic surfactants useful herein include those selected from the group consisting of sodium lauryl sulfate, ammonium lauryl sulfate, ammonium laureth sulfate, sodium laureth sulfate, sodium trideceth sulfate, ammonium cetyl sulfate, sodium cetyl sulfate, ammonium cocoyl isethionate, sodium lauroyl isethionate, sodium lauroyl lactylate, triethanolamine lauroyl lactylate, sodium caproyl lactylate, sodium lauroyl sarcosinate, sodium myristoyl sarcosinate, sodium cocoyl sarcosinate, sodium lauroyl methyl taurate, sodium cocoyl methyl taurate, sodium lauroyl glutamate, sodium myristoyl glutamate, and sodium cocoyl glutamate and mixtures thereof.

Non-Ionic Surfactants

The composition can comprise a nonionic surfactant at concentrations ranging from about 0.1% to about 50%, from about 0.25% to about 30%, from about 0.5% to about 25%, from about 1.0% to about 20%, and from about 1.5% to about 10%, by weight of the cleansing agent.

Non-limiting examples of nonionic surfactants for use in the compositions of the present invention are disclosed in McCutcheon's, Detergents and Emulsifiers, North American edition (1986), published by allured Publishing Corporation; and McCutcheon's, Functional Materials, North American Edition (1992).

Nonionic surfactants useful herein include those selected from the group consisting of alkyl glucosides, polyglucosides, polyhydroxy fatty acid amides, alkoxylated fatty acid esters, sugar esters, ethoxylated esters, glycerol esters, ethoxylates, propoxylates, PEG/PPG copolymers, glycerides, sorbitans, and mixtures. More specifically polyethylene glycol 20 sorbitan monolaurate (Polysorbate 20), polyethylene glycol 5 soya sterol, Steareth-20, Ceteareth-20, PPG-2 methyl glucose ether distearate, Ceteth-10, Polysorbate 80, Polysorbate 60, glyceryl stearate, PEG-100 stearate, polyoxyethylene 20 sorbitan trioleate (Polysorbate 85), sorbitan monolaurate, polyoxyethylene 4 lauryl ether sodium stearate, polyglyceryl-4 isostearate, and mixtures.

Alkyl glucosides and alkyl polyglucosides are useful herein, and can be broadly defined as condensation products of long chain alcohols, e.g., C8-30 alcohols, with sugars or starches or sugar or starch polymers, i.e., glycosides or polyglycosides. These compounds can be represented by the formula (S)ₙ—O—R wherein S is a sugar moiety such as glucose, fructose, mannose, and galactose; n is an integer of from about 1 to about 1000, and R is a C8-30 alkyl group. Examples of long chain alcohols from which the alkyl group can be derived include decyl alcohol, cetyl alcohol, stearyl alcohol, lauryl alcohol, myristyl alcohol, oleyl alcohol, and the like. Preferred examples of these surfactants include those wherein S is a glucose moiety, R is a C8-20 alkyl group, and n is an integer of from about 1 to about 9. Commercially available examples of these surfactants include decyl polyglucoside (available as APG 325 CS from Henkel) and lauryl polyglucoside (available as APG 600CS and 625 CS from Henkel). Also useful are sucrose ester surfactants such as sucrose cocoate and sucrose laurate.

Other useful nonionic surfactants include polyhydroxy fatty acid amide surfactants, more specific examples of which include glucosamides, corresponding to the structural formula:

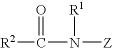

wherein: R¹ is H, C₁-C₄ alkyl, 2-hydroxyethyl, 2-hydroxy-propyl, preferably C₁-C₄ alkyl, more preferably methyl or ethyl, most preferably methyl; R² is C₅-C₃₁ alkyl or alkenyl, preferably C₇-C₁₉ alkyl or alkenyl, more preferably C₉-C₁₇ alkyl or alkenyl, most preferably C₁₁-C₁₅ alkyl or alkenyl; and Z is a polhydroxyhydrocarbyl moiety having a linear hydrocarbyl chain with a least 3 hydroxyls directly connected to the chain, or an alkoxylated derivative (preferably ethoxylated or propoxylated) thereof. Z preferably is a sugar moiety selected from the group consisting of glucose, fructose, maltose, lactose, galactose, mannose, xylose, and mixtures thereof. An especially preferred surfactant corresponding to the above structure is coconut alkyl N-methyl glucoside amide (i.e., wherein the R²CO— moiety is derived from coconut oil fatty acids). Processes for making compositions containing polyhydroxy fatty acid amides are disclosed, for example, in G.B. Patent Specification 809,060, published Feb. 18, 1959, by Thomas Hedley & Co., Ltd.; U.S. Pat. No. 2,965,576, to E. R. Wilson, issued Dec. 20, 1960; U.S. Pat. No. 2,703,798, to A. M. Schwartz, issued Mar. 8, 1955; and U.S. Pat. No. 1,985,424, to Piggott, issued Dec. 25, 1934; each of which are incorporated herein by reference in their entirety.

Other examples of nonionic surfactants include amine oxides. Amine oxides correspond to the general formula R₁R₂R₃N→O, wherein R₁ contains an alkyl, alkenyl or monohydroxy alkyl radical of from about 8 to about 18 carbon atoms, from 0 to about 10 ethylene oxide moieties, and from 0 to about 1 glyceryl moiety, and R₂ and R₃ contain from about 1 to about 3 carbon atoms and from 0 to about 1 hydroxy group, e.g., methyl, ethyl, propyl, hydroxyethyl, or hydroxypropyl radicals. The arrow in the formula is a conventional representation of a semipolar bond. Examples of amine oxides suitable for use in this invention include dimethyl-dodecylamine oxide, oleyldi(2-hydroxyethyl)amine oxide, dimethyloctylamine oxide, dimethyl-decylamine oxide, dimethyl-tetradecylamine oxide, 3,6,9-trioxaheptadecyldiethylamine oxide, di(2-hydroxyethyl)-tetradacylamine oxide, 2-dodecoxyethyldimethylamine oxide, 3-dodecoxy-2-hydroxypropyldi(3-hydroxypropyl)amine oxide, dimethylhexadecylamine oxide.

Nonlimiting examples of nonionic surfactants for use herein are those selected form the group consisting of C8-C14 glucose amides, C8-C14 alkyl polyglucosides, sucrose cocoate, sucrose laurate, lauramine oxide, cocoamine oxide, and mixtures thereof.

Amphoteric Surfactants

The composition can comprise an amphoteric surfactant at concentrations ranging from about 0.1% to about 50%, from about 0.4% to about 30%, from about 0.5% to about 25%, from about 1% to about 20%, from about 2% to about 10%, by weight of the cleansing agent.

The term “amphoteric surfactant,” as used herein, is also intended to encompass zwitterionic surfactants, which are well known to formulators skilled in the art as a subset of amphoteric surfactants.

A wide variety of amphoteric surfactants can be used in the compositions of the present invention. Particularly useful are those which are broadly described as derivatives of aliphatic secondary and tertiary amines, preferably wherein the nitrogen is in a cationic state, in which the aliphatic radicals can be straight or branched chain and wherein one of the radicals contains an ionizable water solubilizing group, e.g., carboxy, sulfonate, sulfate, phosphate, or phosphonate.

Nonlimiting examples of amphoteric surfactants useful in the compositions of the present invention are disclosed in McCutcheon's, Detergents and Emulsifiers, North American edition (1986), published by allured Publishing Corporation; and McCutcheon's, Functional Materials, North American Edition (1992); both of which are incorporated by reference herein in their entirety.

Nonlimiting examples of amphoteric or zwitterionic surfactants are those selected from the group consisting of amine oxides, betaines, sultaines, hydroxysultaines, alkyliminoacetates, iminodialkanoates, aminoalkanoates, and mixtures thereof.

Examples of betaines include the higher alkyl betaines, such as coco dimethyl carboxymethyl betaine, lauryl dimethyl carboxymethyl betaine, lauryl dimethyl alpha-carboxyethyl betaine, cetyl dimethyl carboxymethyl betaine, cetyl dimethyl betaine (available as Lonzaine 16SP from Lonza Corp.), lauryl bis-(2-hydroxyethyl) carboxymethyl betaine, oleyl dimethyl gamma-carboxypropyl betaine, lauryl bis-(2-hydroxypropyl)alpha-carboxyethyl betaine, coco dimethyl sulfopropyl betaine, lauryl dimethyl sulfoethyl betaine, lauryl bis-(2-hydroxyethyl) sulfopropyl betaine, amidobetaines and amidosulfobetaines (wherein the RCONH(CH₂)₃ radical is attached to the nitrogen atom of the betaine), oleyl betaine (available as amphoteric Velvetex OLB-50 from Henkel), and cocamidopropyl betaine (available as Velvetex BK-35 and BA-35 from Henkel).

Examples of sultaines and hydroxysultaines include materials such as cocamidopropyl hydroxysultaine (available as Mirataine CBS from Rhone-Poulenc).

Preferred for use herein are amphoteric surfactants having the following structure:

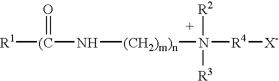

wherein R¹ is unsubstituted, saturated or unsaturated, straight or branched chain alkyl having from about 9 to about 22 carbon atoms. Preferred R¹ has from about 11 to about 18 carbon atoms; more preferably from about 12 to about 18 carbon atoms; more preferably still from about 14 to about 18 carbon atoms; m is an integer from 1 to about 3, more preferably from about 2 to about 3, and more preferably about 3; n is either 0 or 1, preferably 1; R² and R³ are independently selected from the group consisting of alkyl having from 1 to about 3 carbon atoms, unsubstituted or mono-substituted with hydroxy, preferred R² and R³ are CH₃; X is selected from the group consisting of CO₂, SO3 and SO₄; R⁴ is selected from the group consisting of saturated or unsaturated, straight or branched chain alkyl, unsubstituted or monosubstituted with hydroxy, having from 1 to about 5 carbon atoms. When X is CO₂, R⁴ preferably has 1 or 3 carbon atoms, more preferably 1 carbon atom. When X is SO₃ or SO₄, R⁴ preferably has from about 2 to about 4 carbon atoms, more preferably 3 carbon atoms.

Examples of amphoteric surfactants of the present invention include the following compounds:

Cetyl dimethyl betaine (this material also has the CTFA designation cetyl betaine)

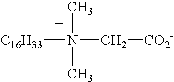

Cocamidopropylbetaine

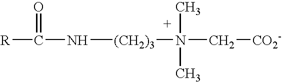

wherein R has from about 9 to about 13 carbon atoms

Cocamidopropyl hydroxy sultaine

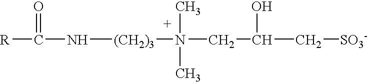

wherein R has from about 9 to about 13 carbon atoms,

Examples of other useful amphoteric surfactants are alkyliminoacetates, and iminodialkanoates and aminoalkanoates of the formulas RN[CH₂)ₘCO₂M]₂ and RNH(CH₂)ₘCO₂M wherein m is from 1 to 4, R is a C₈-C₂₂ alkyl or alkenyl, and M is H, alkali metal, alkaline earth metal ammonium, or alkanolammonium. Also included are imidazolinium and ammonium derivatives. Specific examples of suitable amphoteric surfactants include sodium 3-dodecyl-aminopropionate, sodium 3-dodecylaminopropane sulfonate, N-higher alkyl aspartic acids such as those produced according to the teaching of U.S. Pat. No. 2,438,091 which is incorporated herein by reference in its entirety; and the products sold under the trade name “Miranol” and described in U.S. Pat. No. 2,528,378, which is incorporated herein by reference in its entirety. Other examples of useful amphoterics include amphoteric phosphates, such as coamidopropyl PG-dimonium chloride phosphate (commercially available as Monaquat PTC, from Mona Corp.). Also useful are amphoacetates such as disodium lauroamphodiacetate, sodium lauroamphoacetate, and mixtures thereof.

Amphoacetates and diamphoacetates may also be used.

### Amphoacetate

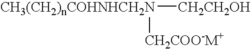

### Diamphoacetate

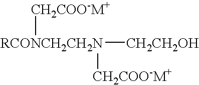

Amphoacetates and diamphoacetates conform to the formulas (above) where R is an aliphatic group of 8 to 18 carbon atoms. M is a cation such as sodium, potassium, ammonium, or substituted ammonium. Sodium lauroamphoacetate, sodium cocoamphoactetate, disodium lauroamphoacetate, and disodium cocodiamphoacetate are preferred in some embodiments.

The composition may further comprise at least one zwitterionic surfactant. The composition comprises an zwitterionic surfactant at concentrations ranging from about 0.1% to about 50%, from about 0.4% to about 30%, from about 0.5% to about 25%, from about 1% to about 20%, from about 2% to about 10%, by weight of the cleansing agent.

Zwitterionic surfactants suitable for use in the compositions inchlde those that are broadly described as derivatives of aliphatic quaternary ammonium, phosphonium, and sulfonium compounds, in which the aliphatic radicals can be straight or branched chain, and wherein one of the aliphatic substituents contains from about 8 to about 18 carbon atoms and one contains an anionic group, e.g., carboxy, sulfonate, sulfate, phosphate, or phosphonate. Such suitable zwitterionic surfactants can be represented by the formula:

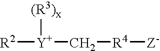

wherein R² contains an alkyl, alkenyl, or hydroxy alkyl radical of from about 8 to about 18 carbon atoms, from 0 to about 10 ethylene oxide moieties and from 0 to about 1 glyceryl moiety; Y is selected from the group consisting of nitrogen, phosphorus, and sulfur atoms; R³ is an alkyl or monohydroxyalkyl group containing about 1 to about 3 carbon atoms; X is 1 when Y is a sulfur atom, and 2 when Y is a nitrogen or phosphorus atom; R⁴ is an alkylene or hydroxyalkylene of from about 1 to about 4 carbon atoms and Z is a radical selected from the group consisting of carboxylate, sulfonate, sulfate, phosphonate, and phosphate groups.

Other zwitterionic surfactants suitable for use in the compositions include betaines, including high alkyl betaines such as coco dimethyl carboxymethyl betaine, cocoamidopropyl betaine, cocobetaine, lauryl amidopropyl betaine, oleyl betaine, lauryl dimethyl carboxymethyl betaine, lauryl dimethyl alphacarboxyethyl betaine, cetyl dimethyl carboxymethyl betaine, lauryl bis-(2-hydroxyethyl) carboxymethyl betaine, stearyl bis-(2-hydroxypropyl) carboxymethyl betaine, oleyl dimethyl gamma-carboxypropyl betaine, and lauryl bis-(2-hydroxypropyl)alpha-carboxyethyl betaine. The sulfobetaines may be represented by coco dimethyl sulfopropyl betaine, stearyl dimethyl sulfopropyl betaine, lauryl dimethyl sulfoethyl betaine, lauryl bis-(2-hydroxyethyl) sulfopropyl betaine and the like; amidobetaines and amidosulfobetaines, wherein the RCONH(CH₂)₃ radical is attached to the nitrogen atom of the betaine are also useful in this invention.

Cationic surfactants can also be used in the compositions, but are generally less preferred, and preferably represent less than about 5% by weight of the compositions.

B. Conditioning Agents

The compositions of the present invention can comprise a conditioning agent that is useful for providing a conditioning benefit to the skin, hair and other parts of the companion animal's body. The conditioning agents can be associated with the implement alone or in combination with cleansing agents, and/or treatment agents. The conditioning agent can comprise no more than about 1600 weight percent, no more than about 1000 weight percent, no more than about 800 weight percent, no more than about 600 weight percent by weight of the implement of a conditioning agent. The conditioning agent can comprise at least 0.05 weight percent, at least 15 weight percent, at least 15 weight percent, and no more than about 60 weight percent by weight of the implement of a conditioning agent.

The conditioning agent useful in the present invention can comprise: a water soluble conditioning agent; an oil soluble conditioning agent; a conditioning emulsion; or any combination or permutation of the three. The oil soluble conditioning agent is selected from one or more oil soluble conditioning agents such that the weighted arithmetic mean solubility parameter of the oil soluble conditioning agent is less than or equal to 10.5. The water soluble conditioning agent is selected from one or more water soluble conditioning agents such that the weighted arithmetic mean solubility parameter of the water soluble conditioning agent is greater than 10.5. It is recognized, based on this mathematical definition of solubility parameters, that it is possible, for example, to achieve the required weighted arithmetic mean solubility parameter, i.e. less than or equal to 10.5, for an oil soluble conditioning agent comprising two or more compounds if one of the compounds has an individual solubility parameter greater than 10.5. Conversely, it is possible to achieve the appropriate weighted arithmetic mean solubility parameter, i.e. greater than 10.5, for a water soluble conditioning agent comprising two or more compounds if one of the compounds has an individual solubility parameter less than or equal to 10.5.

Solubility parameters are well known to the formulation chemist of ordinary skill in the art and are routinely used as a guide for determining compatibilities and solubilities of materials in the formulation process. See “Solubility Effects in Product, Package, Penetration, and Preservation”, Cosmetics and Toiletries vol. 103, p 47-69, (October 1988).

Non-limiting examples of useful conditioning agents include those selected from the group consisting of silicone oil, silicone polymers, functional silicone polymers, fatty acids, esters of fatty acids, fatty alcohols, ethoxylates, polyol polyesters, glycerine, glycerin mono-esters, glycerin polyesters, epidermal and sebaceous hydrocarbons, lanolin, straight and branched hydrocarbons, silicone gum, vegetable oil, vegetable oil adduct, hydrogenated vegetable oils, nonionic polymers, natural waxes, petrolatum, petrolatum derivatives, synthetic waxes, polyolefinic glycols, polyolefinic monoester, polyolefinic polyesters, cholesterols, cholesterol esters, triglycerides and mixtures thereof.

More particularly, the conditioning agent may be selected from the group consisting of paraffin, mineral oil, petrolatum, stearyl alcohol, cetyl alchohol, cetearyl alcohol, behenyl alcohol, C10-30 polyesters of sucrose, stearic acid, palmitic acid, behenic acid, oleic acid, linoleic acid, myristic acid, lauric acid, ricinoleic acid, steareth-1-100, cetereath 1-100, cholesterols, cholesterol esters, glyceryl tribehenate, glyceryl dipalmitate, glyceryl monostearate, trihydroxystearin, ozokerite wax, jojoba wax, lanolin wax, ethylene glycol distearate, candelilla wax, carnauba wax, beeswax, and silicone waxes.

Mineral oil, which is also known as petrolatum liquid, is a mixture of liquid hydrocarbons obtained from petroleum. See The Merck Index, Tenth Edition, Entry 7048, p. 1033 (1983) and International Cosmetic Ingredient Dictionary, Fifth Edition, vol. 1, p. 415-417 (1993).

Petrolatum, which is also known as petroleum jelly, is a colloidal system comprising nonstraight-chain solid hydrocarbons and high-boiling liquid hydrocarbons. See The Merck Index, Tenth Edition, Entry 7047, p. 1033 (1983); Schindler, Drug. Cosmet. Ind., p. 89, 36-37, 76, 78-80, 82 (1961); and International Cosmetic Ingredient Dictionary, Fifth Edition, Vol. 1, p. 537 (1993).

Nonvolatile silicones such as polydialkylsiloxanes, polydiarylsiloxanes, and polyalkarylsiloxanes are also useful skin conditioning agents. These silicones are disclosed in U.S. Pat. No. 5,069,897, to Orr, issued Dec. 3, 1991.

The conditioning agent preferably used in the present invention may also comprise a conditioning emulsion that is useful for providing a conditioning benefit to the skin, hair, paws and nails during the use of the implement. The term “conditioning emulsion” as used herein can either mean the combination of an internal phase comprising a water soluble conditioning agent that is enveloped by an external phase comprising an oil soluble agent or the term “conditioning emulsion” as used herein means the combination of an internal phase comprising an oil soluble agent that is enveloped by an external phase comprising a water soluble agent. In preferred embodiments, the conditioning emulsion would further comprise an emulsifier. The conditioning emulsion comprises from about 15% to about 1600%, from about 25% to about 1000%, from about 50% to about 800%, and from about 60% to about 600% by weight of said implement. In a preferred embodiment the conditioning emulsion comprises (i) an internal phase comprising water soluble conditioning agents as described above, and (ii) an external phase comprising oil soluble agents as described hereinbefore in the oil soluble conditioning agent section or hereinafter in the “Materials Used to Increase Lipid Hardness Value” section. In further embodiments, the conditioning emulsion further comprises an emulsifier capable of forming an emulsion of said internal and external phases. Although an emulsifier capable of forming an emulsion of the internal and external phases is preferred in the present invention, it is recognized in the art of skin care formulations that a water soluble conditioning agent can be enveloped by an oil soluble agent without an emulsifier.

C. Treatment Agents

The compositions of the present invention can comprise a treatment agent that is useful for providing a therapeutic benefit and/or cosmetic benefit to the skin, hair, paws, ears, nails and similar keratin-containing surfaces of the companion animal during the use of the implement. The treatment agents are suitable for application to keratin-containing tissue, that is, they are suitable for use in contact with companion animal without undue toxicity, incompatibility, instability, allergic response, and the like.

The treatment agents useful in the present invention can comprise compositions comprising the following nonlimiting examples, vitamins, cyclodextrins, zeolites, peptides, sunscreen actives, terpene alcohols, desquamation actives including a combination of sulfhydryl compounds and zwitterionic surfactants, and a combination of salicylic acid and zwitterionic surfactants, anti-atrophy actives, anti-oxidants/radical scavengers, flavonoids, anti-inflammatory agent, topical anesthetics, chelators, antimicrobial and antifungal actives, skin soothing and skin healing actives, flea actives, moisturizing actives, tick actives, other insect active, and mixtures thereof.

The treatment agent can comprise no more than about 1600 weight percent, no more than about 1000 weight percent, preferably no more than about 800 weight percent, and no more than about 600 weight percent by weight of the implement of a treatment agent. The treatment agent can comprise at least 0.05 weight percent, at least 15 weight percent, preferably at least 20 weight percent, and at least about 60 weight percent by the weight of the implement of a treatment agent.

### Combination Cleansing, Conditioning and Treatment Compositions

These implements can comprise at least two separate cleansing, conditioning and treatment compositions on a single implement, at least three, at least four, at least five and so on a single implement. The compositions can be added separately or the compositions can be mixed together prior to being associated with the implement of the present invention.

### Additional Ingredients

The compositions of the present invention can comprise a wide range of other optional components. These additional components should be pharmaceutically acceptable. The CTFA Cosmetic Ingredient Handbook, Second Edition, 1992, describes a wide variety of nonlimiting cosmetic and pharmaceutical ingredients commonly used in the skin care industry, which are suitable for use in the compositions of the present invention. Nonlimiting examples of functional classes of ingredients are described at page 537 of this reference. Examples of these and other functional classes include: abrasives, absorbents, antioxidants, binders, biological additives, buffering agents, bulking agents, chemical additives, colorants, cosmetic biocides, denaturants, drug astringents, external analgesics, film formers, fragrance components, humectants, opacifying agents, pH adjusters, preservatives, propellants, reducing agents, and skin bleaching agents.

Also useful herein are aesthetic components such as fragrances, pigments, colorings, essential oils, skin sensates, astringents, skin soothing agents, and skin healing agents.

The compositions used in the present invention may also contain a “fluid” such as water, mono- and polyhydric alcohols (glycerin, propylene glycol, ethanol, isopropanol, etc.), hydrocarbon oils such as mineral oil, silicone oils having a viscosity, and can contain other components dissolved or dispersed within them, or in addition to them.

Nonlimiting Embodiments of Disposable Nonwoven Implement

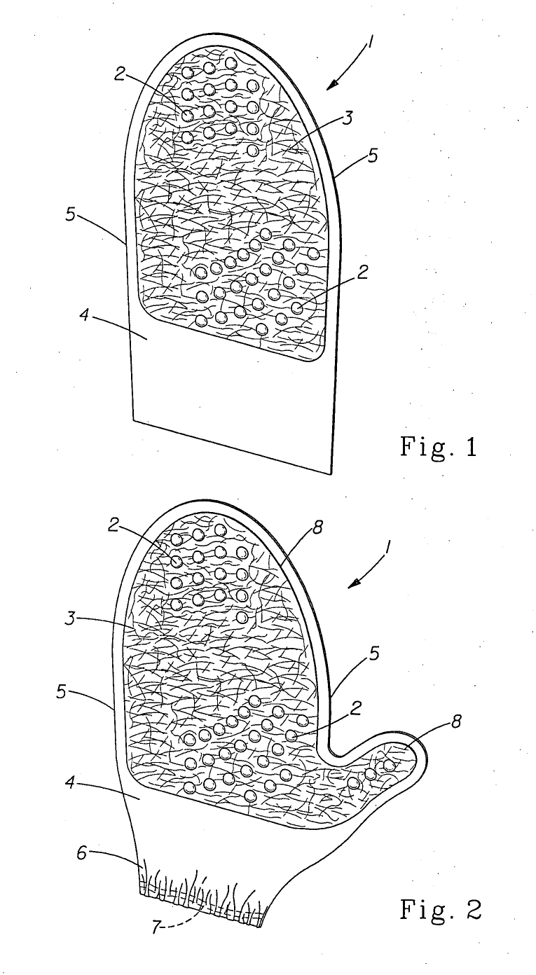

The present invention encompasses a disposable nonwoven implement 1 as illustrated in FIG. 1-30. Each of the following disposable nonwoven implement embodiments can comprise a composition 3 associated with the disposable nonwoven implement 1 illustrated in Examples 1-30.

FIG. 1 illustrates one possible embodiment of a disposable nonwoven implement 1 that is a mitt comprising a first nonwoven sheet member 4, a periphery 5, and a composition 3 associated with the disposable nonwoven implement 1. The disposable nonwoven implement 1 comprises raised elements 2 on the surface of the nonwoven sheet member 4.

FIG. 2 illustrates one possible embodiment of a disposable nonwoven implement 1 that is a mitten comprising a first nonwoven sheet member 4, a periphery 5, and a composition 3 associated with the disposable nonwoven implement 1. The disposable nonwoven implement 1 comprises raised elements 2 on the surface of the nonwoven sheet member 4. The disposable nonwoven implement also comprise two sleeves 8, a wrist portion 6 comprising a closure means 7. The closure means 7 in this embodiment is elastic.

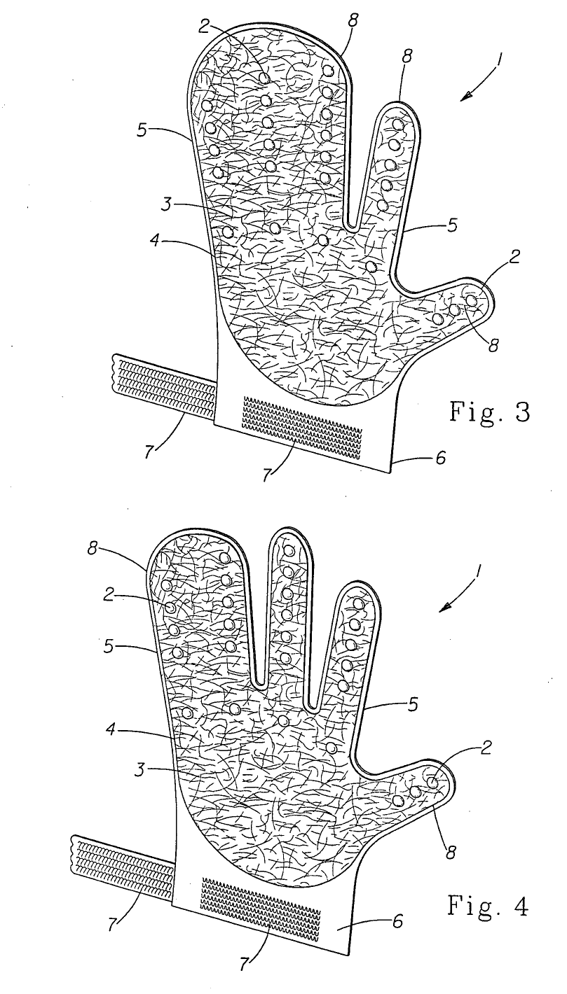

FIG. 3 illustrates one possible embodiment of a disposable nonwoven implement 1 that is a glove comprising a first nonwoven sheet member 4, a periphery 5, and a composition 3 associated with the disposable nonwoven implement 1. The disposable nonwoven implement 1 comprises raised elements 2 on the surface of the nonwoven sheet member 4. The disposable nonwoven implement also comprise three sleeves 8, a wrist portion 6 comprising a closure means 7. The closure means 7 in this embodiment is a Velcro® closure strip.

FIG. 4 illustrates one possible embodiment of a disposable nonwoven implement 1 that is a glove comprising a first nonwoven sheet member 4, a periphery 5, and a composition 3 associated with the disposable nonwoven implement 1. The disposable nonwoven implement 1 comprises raised elements 2 on the surface of the nonwoven sheet member 4. The disposable nonwoven implement also comprise four sleeves 8, a wrist portion 6 comprising a closure means 7. The closure means 7 in this embodiment is a Velcro® closure strip.

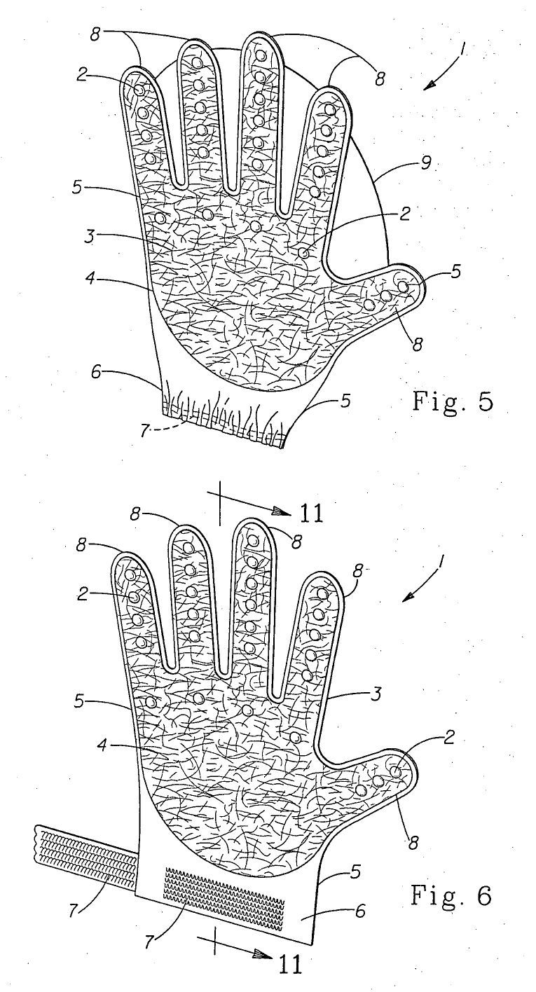

FIG. 5 illustrates one possible embodiment of a disposable nonwoven implement 1 that is a glove comprising a first nonwoven sheet member 4, a periphery 5, and a composition 3 associated with the disposable nonwoven implement 1. The disposable nonwoven implement 1 comprises raised elements 2 on the surface of the nonwoven sheet member 4. The disposable nonwoven implement also comprise five sleeves 8, a wrist portion 6 comprising a closure means 7. The closure means 7 in this embodiment is elastic. Additionally, the five sleeves 8 are connected to one another with a webbing 9 located between each sleeve 8.

FIG. 6 illustrates one possible embodiment of a disposable nonwoven implement 1 that is a glove comprising a first nonwoven sheet member 4, a periphery 5, and a composition 3 associated with the disposable nonwoven implement 1. The disposable nonwoven implement 1 comprises raised elements 2 on the surface of the nonwoven sheet member 4. The disposable nonwoven implement also comprise five sleeves 8, a wrist portion 6 comprising a closure means 7. The closure means 7 in this embodiment is a Velcro® closure strip.

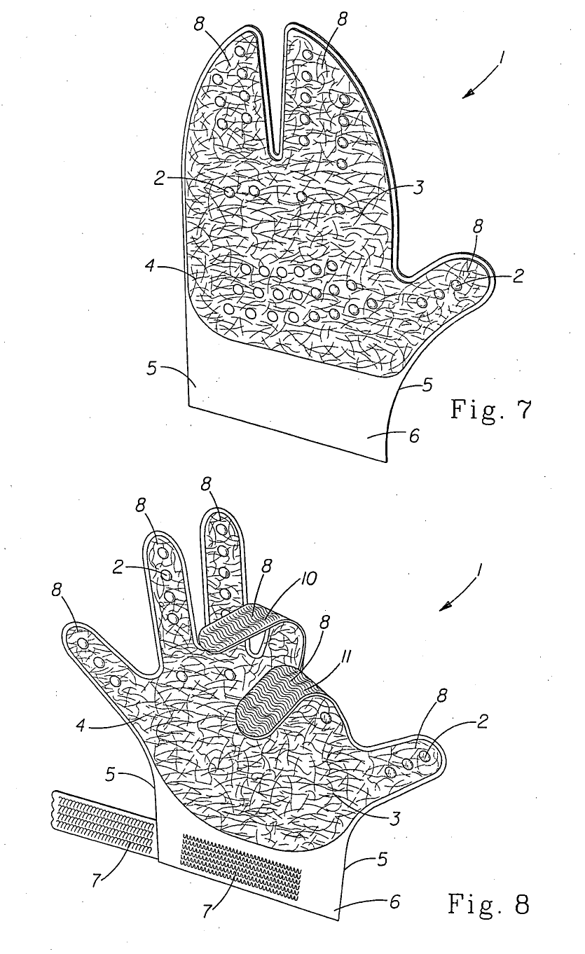

FIG. 7 illustrates one possible embodiment of a disposable nonwoven implement 1 that is a glove comprising a first nonwoven sheet member 4, a periphery 5, and a composition 3 associated with the disposable nonwoven implement 1. The disposable nonwoven implement 1 comprises raised elements 2 on the surface of the nonwoven sheet member 4. The disposable nonwoven implement also comprise three sleeves 8 and a wrist portion 6.

FIG. 8 illustrates one possible embodiment of a disposable nonwoven implement 1 that is a glove comprising a first nonwoven sheet member 4, a second nonwoven sheet member 10, a periphery 5, and a composition 3 associated with the disposable nonwoven implement 1. The disposable nonwoven implement 1 comprises raised elements 2 on the surface of the first nonwoven sheet member 4 and texture 11 on the second nonwoven sheet member 10. The disposable nonwoven implement also comprise six sleeves 8, a wrist portion 6 comprising a closure means 7. The closure means 7 in this embodiment is a Velcro® closure strip.

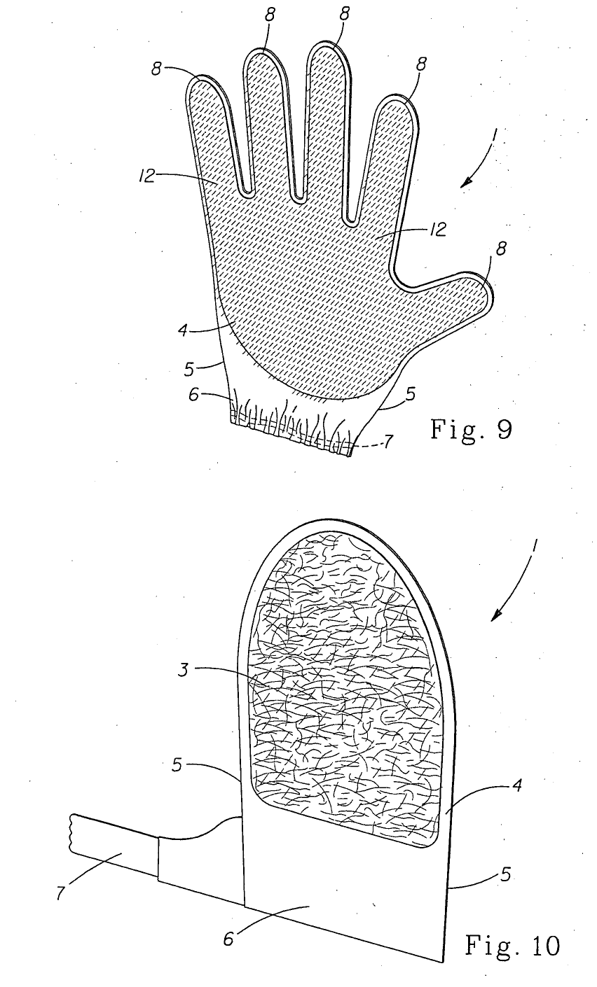

FIG. 9 illustrates one possible embodiment of a disposable nonwoven implement 1 that is a glove comprising a first nonwoven sheet member 4 and a periphery 5. The disposable nonwoven implement 1 comprises a material 12 for collecting hair on the surface of the nonwoven sheet member 4. The material 12 is bristles. The disposable nonwoven implement 1 also comprise five sleeves 8, a wrist portion 6 comprising a closure means 7. The closure means 7 in this embodiment is elastic.

FIG. 10 illustrates one possible embodiment of a disposable nonwoven implement 1 that is a mitt comprising a first nonwoven sheet member 4, a periphery 5, and a composition 3 associated with the disposable nonwoven implement 1. The disposable nonwoven implement 1 comprises a wrist portion 6 comprising a closure means 7. The closure means 7 in this embodiment is tape.

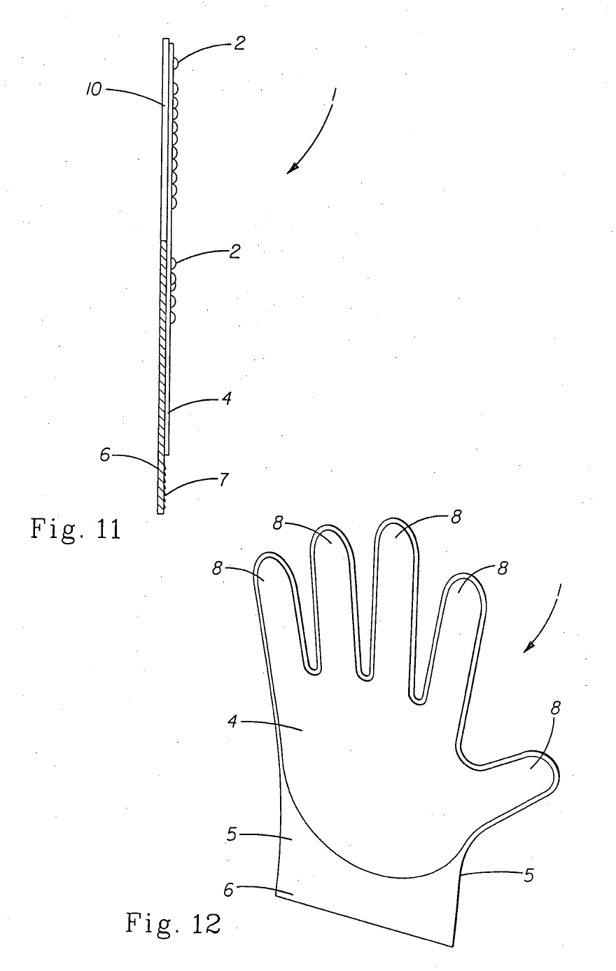

FIG. 11 illustrates a side view of a disposable nonwoven implement 1. The disposable nonwoven implement 1 comprises a first nonwoven sheet member 4 and a second nonwoven sheet member 10. The disposable nonwoven implement 1 comprises raised elements 2 on the surface of the first nonwoven sheet member 4. The disposable nonwoven implement also comprises a wrist portion 6 comprising a closure means 7. The closure means 7 in this embodiment is a Velcro® closure strip.

FIG. 12 illustrates one possible embodiment of a disposable nonwoven implement 1 that is a glove comprising a first nonwoven sheet member 4 and a periphery 5. The disposable nonwoven implement also comprise five sleeves 8 and a wrist portion 6.

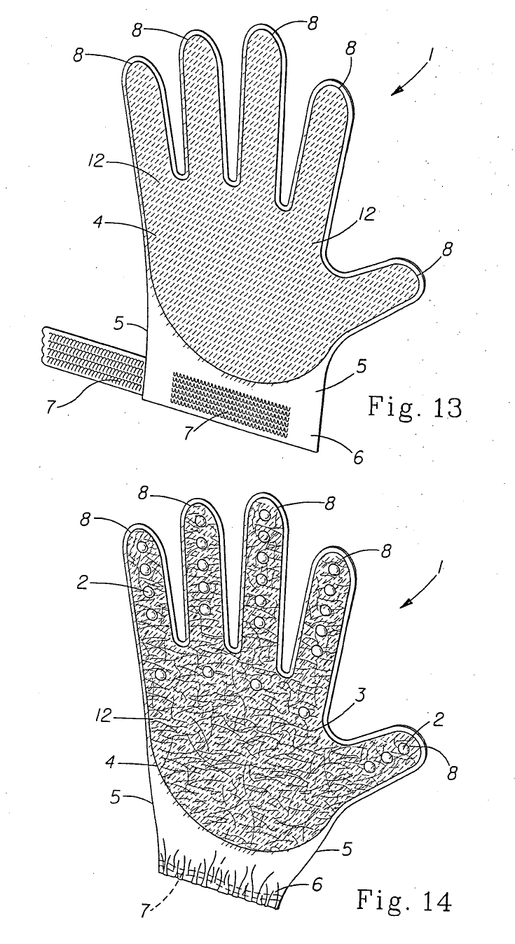

FIG. 13 illustrates one possible embodiment of a disposable nonwoven implement 1 that is a glove comprising a first nonwoven sheet member 4 and a periphery 5. The disposable nonwoven implement 1 comprises a material 12 for collecting hair on the surface of the nonwoven sheet member 4. The material 12 is protrusions from the nonwoven. The disposable nonwoven implement 1 also comprises five sleeves 8, a wrist portion 6 comprising a closure means 7. The closure means 7 in this embodiment is a Velcro® closure strip.

FIG. 14 illustrates one possible embodiment of a disposable nonwoven implement 1 that is a glove comprising a first nonwoven sheet member 4, a periphery 5, and a composition 3 associated with the disposable nonwoven implement 1. The disposable nonwoven implement 1 comprises raised elements 2 on the surface of the first nonwoven sheet member 4. The disposable nonwoven implement 1 comprises a material 12 for collecting hair on the surface of the nonwoven sheet member 4. The material 12 is protrusions from the nonwoven. The disposable nonwoven implement 1 also comprise five sleeves 8, a wrist portion 6 comprising a closure means 7. The closure means 7 in this embodiment is elastic.

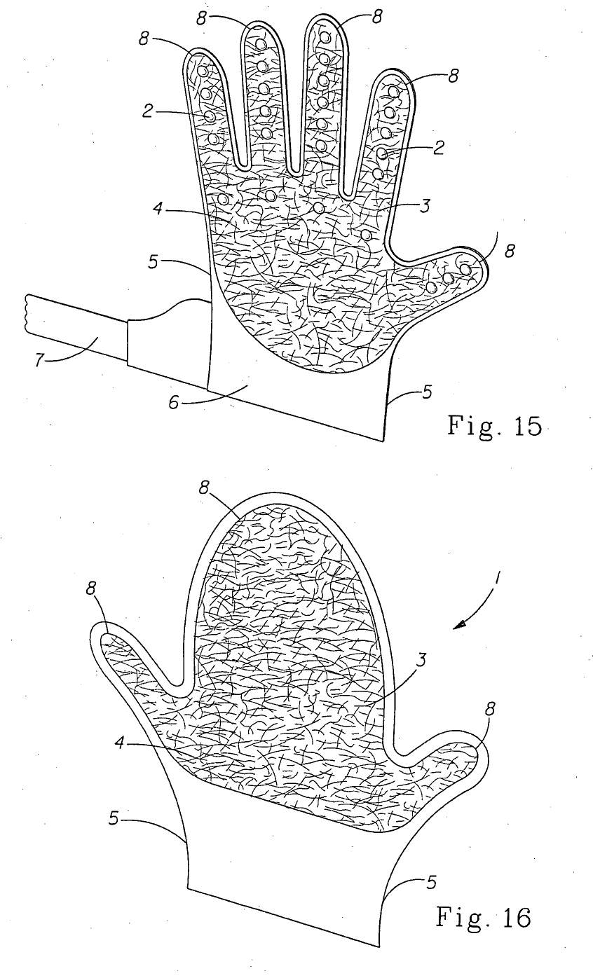

FIG. 15 illustrates one possible embodiment of a disposable nonwoven implement 1 that is a glove comprising a first nonwoven sheet member 4, a periphery 5, and a composition 3 associated with the disposable nonwoven implement 1. The disposable nonwoven implement 1 comprises raised elements 2 on the surface of the first nonwoven sheet member 4. The disposable nonwoven implement 1 also comprise five sleeves 8, a wrist portion 6 comprising a closure means 7. The closure means 7 in this embodiment is tape.

FIG. 16 illustrates one possible embodiment of a disposable nonwoven implement 1 that is a glove comprising a first nonwoven sheet member 4, a periphery 5, and a composition 3 associated with the disposable nonwoven implement 1. The disposable nonwoven implement also comprise three sleeves 8 and a wrist portion 6. The glove can be worn on either hand of the user.

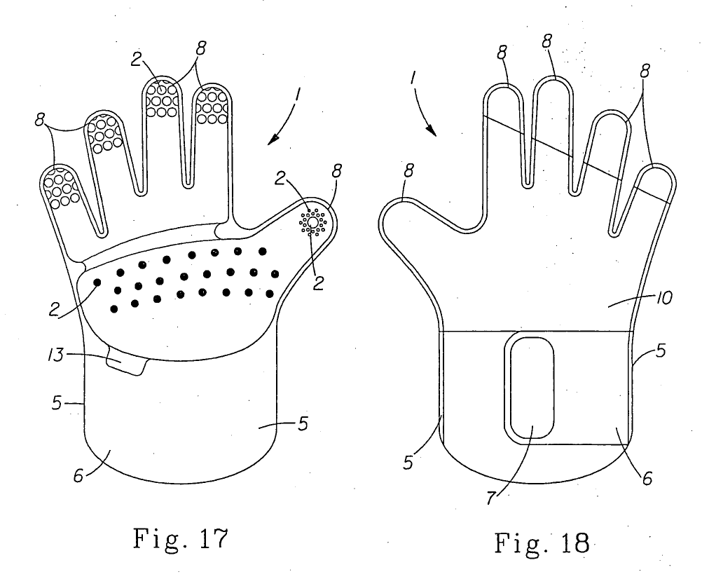

FIG. 17 illustrates a front view of a disposable nonwoven implement 1 that is a glove comprising a first nonwoven sheet member 4 and a periphery 5. The disposable nonwoven implement 1 comprises raised elements 2 on the surface of the first nonwoven sheet member 4. The disposable nonwoven implement 1 also comprise five sleeves 8 and a wrist portion 6. The disposable nonwoven implement 1 also comprises a tab 13 that can assist the user in putting the disposable nonwoven implement 1 on and taking the disposable nonwoven implement 1 off.

FIG. 18 illustrates a back view of a disposable nonwoven implement 1 that was described in FIG. 17. The disposable nonwoven implement 1 is a glove comprising a second nonwoven sheet member 10 and a periphery 5. The disposable nonwoven implement also comprise five sleeves 8, a wrist portion 6 comprising a closure means 7. The closure means 7 in this embodiment is a Velcro® closure strip.

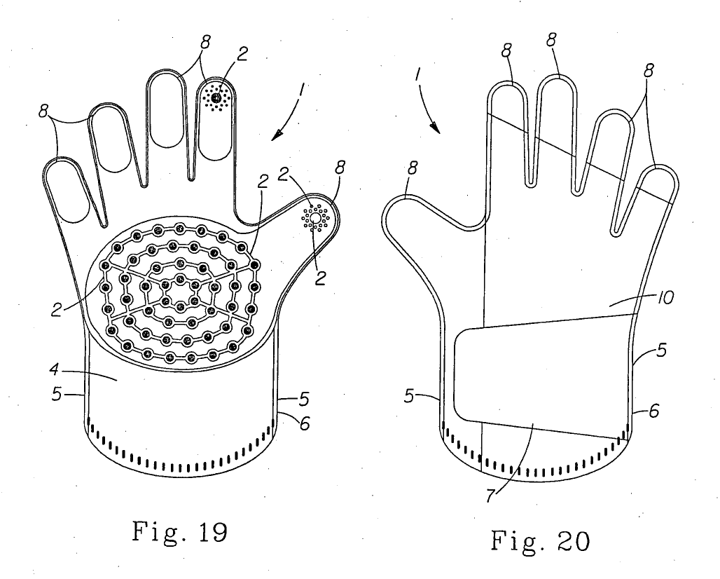

FIG. 19 illustrates a front view of a disposable nonwoven implement 1 that is a glove comprising a first nonwoven sheet member 4 and a periphery 5. The disposable nonwoven implement 1 comprises raised elements 2 on the surface of the first nonwoven sheet member 4. The disposable nonwoven implement 1 also comprise five sleeves 8 and a wrist portion 6.

FIG. 20 illustrates a back view of a disposable nonwoven implement 1 that was described in FIG. 19. The disposable nonwoven implement 1 is a glove comprising a second nonwoven sheet member 10 and a periphery 5. The disposable nonwoven implement also comprise five sleeves 8, a wrist portion 6 comprising a closure means 7. The closure means 7 in this embodiment is a Velcro® closure strip.

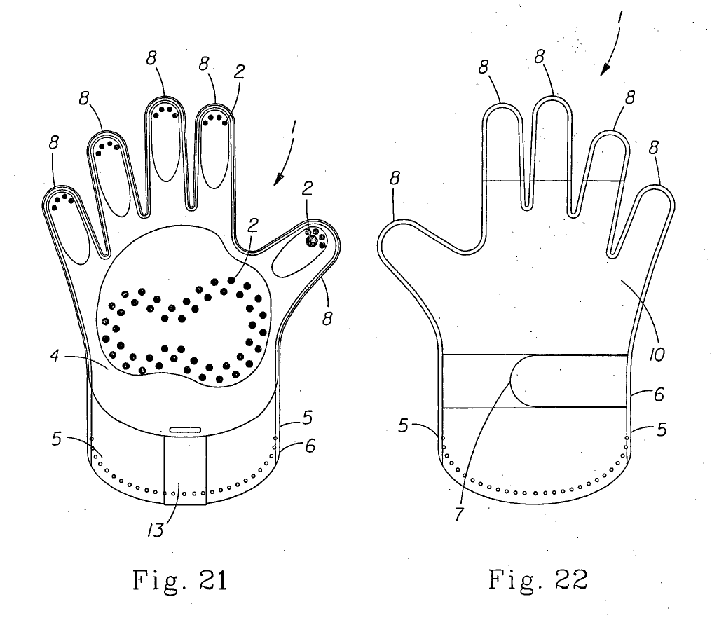

FIG. 21 illustrates a front view of a disposable nonwoven implement 1 that is a glove comprising a first nonwoven sheet member 4 and a periphery 5. The disposable nonwoven implement 1 comprises raised elements 2 on the surface of the first nonwoven sheet member 4. The disposable nonwoven implement 1 also comprise five sleeves 8 and a wrist portion 6. The disposable nonwoven implement 1 also comprises a tab 13 that can assist the user in putting the disposable nonwoven implement 1 on and taking the disposable nonwoven implement 1 off.

FIG. 22 illustrates a back view of a disposable nonwoven implement 1 that was described in FIG. 21. The disposable nonwoven implement 1 is a glove comprising a second nonwoven sheet member 10 and a periphery 5. The disposable nonwoven implement also comprise five sleeves 8, a wrist portion 6 comprising a closure means 7. The closure means 7 in this embodiment is tape.

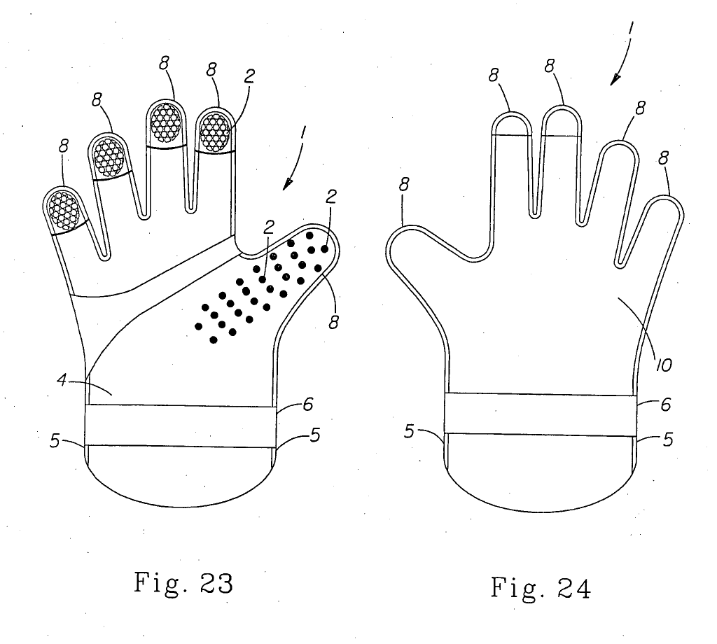

FIG. 23 illustrates a front view of a disposable nonwoven implement 1 that is a glove comprising a first nonwoven sheet member 4 and a periphery 5. The disposable nonwoven implement 1 comprises raised elements 2 on the surface of the first nonwoven sheet member 4. The disposable nonwoven implement 1 also comprise five sleeves 8 and a wrist portion 6.

FIG. 24 illustrates a back view of a disposable nonwoven implement 1 that was described in FIG. 23. The disposable nonwoven implement 1 is a glove comprising a second nonwoven sheet member 10 and a periphery 5. The disposable nonwoven implement also comprise five sleeves 8 and a wrist portion 6.

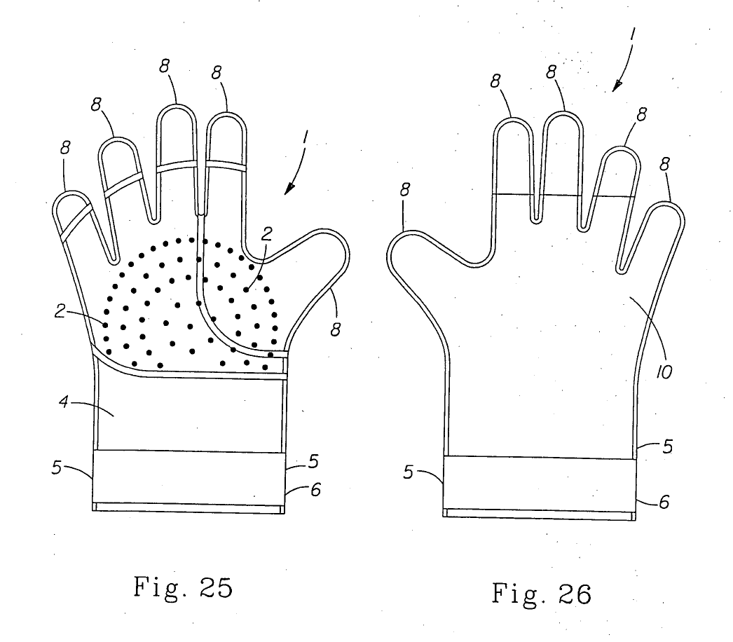

FIG. 25 illustrates a front view of a disposable nonwoven implement 1 that is a glove comprising a first nonwoven sheet member 4 and a periphery 5. The disposable nonwoven implement 1 comprises raised elements 2 on the surface of the first nonwoven sheet member 4. The disposable nonwoven implement 1 also comprise five sleeves 8 and a wrist portion 6.

FIG. 26 illustrates a back view of a disposable nonwoven implement 1 that was described in FIG. 25. The disposable nonwoven implement 1 is a glove comprising a second nonwoven sheet member 10 and a periphery 5. The disposable nonwoven implement also comprise five sleeves 8 and a wrist portion 6.

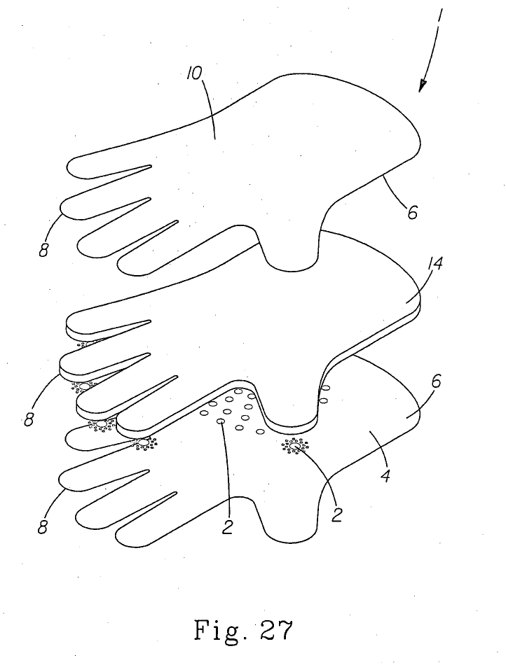

FIG. 27 illustrates an exploded perspective view of a disposable nonwoven implement 1 that is a glove comprising a first nonwoven sheet member 4, a second nonwoven sheet member 10, and a third nonwoven sheet member 14. The disposable nonwoven implement 1 also comprise five sleeves 8 and a wrist portion 6. The disposable nonwoven implement 1 comprises raised elements 2 between the first nonwoven sheet member 4 and the third nonwoven sheet member 14.

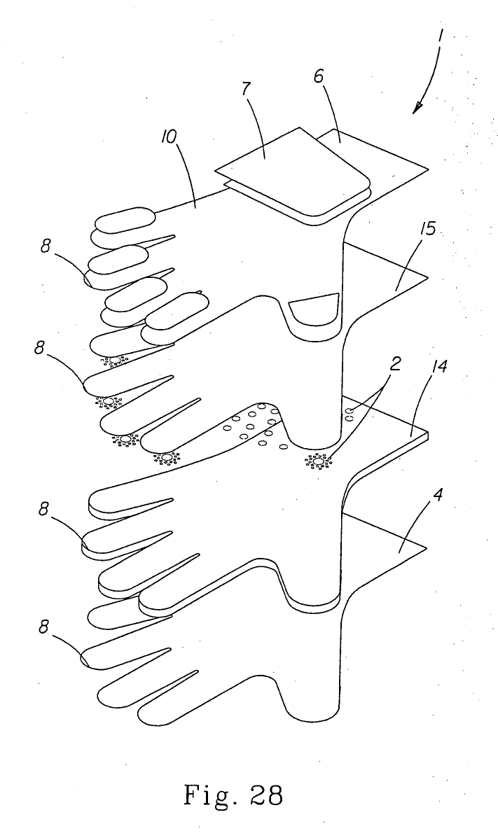

FIG. 28 illustrates an exploded perspective view of a disposable nonwoven implement 1 that is a glove comprising a first nonwoven sheet member 4, a second nonwoven sheet member 10, a third nonwoven sheet member 14, and a fourth nonwoven sheet member 15. The disposable nonwoven implement 1 also comprise five sleeves 8 and a wrist portion 6 comprising a closure means 7. The closure means 7 in this embodiment is a Velcro® closure strip. The disposable nonwoven implement 1 comprises raised elements 2 between the third nonwoven sheet member 14 and the fourth nonwoven sheet member 15.

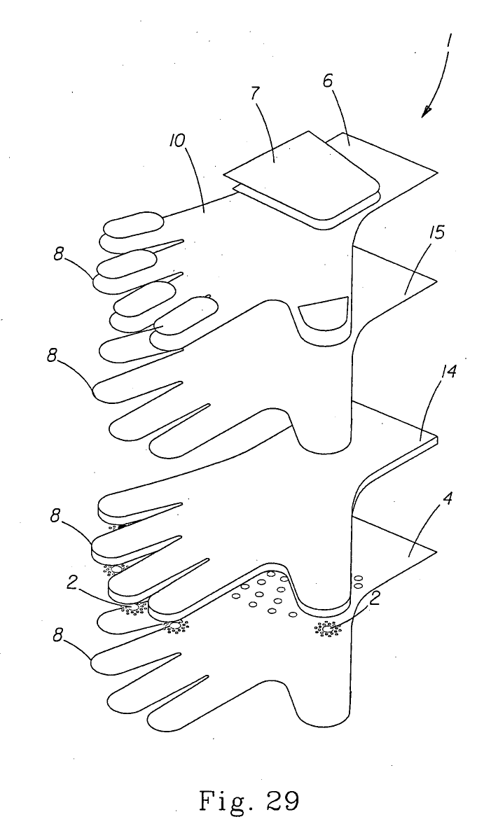

FIG. 29 illustrates an exploded perspective view of a disposable nonwoven implement 1 that is a glove comprising a first nonwoven sheet member 4, a second nonwoven sheet member 10, a third nonwoven sheet member 14, and a fourth nonwoven sheet member 15. The disposable nonwoven implement 1 also comprise five sleeves 8 and a wrist portion 6 comprising a closure means 7. The closure means 7 in this embodiment is a Velcro® closure strip. The disposable nonwoven implement 1 comprises raised elements 2 between the first nonwoven sheet member 4 and the third nonwoven sheet member 14.

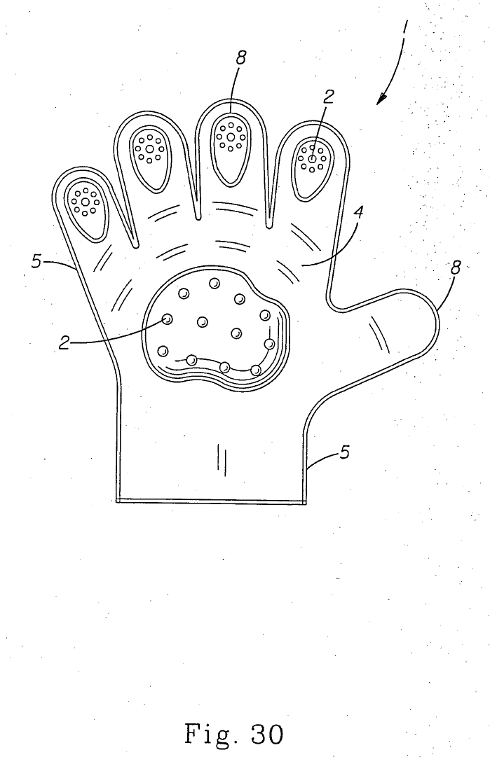

FIG. 30 illustrates a front view of a disposable nonwoven implement 1 that is a glove comprising a first nonwoven sheet member 4 and a periphery 5. The disposable nonwoven implement 1 comprises raised elements 2 on the surface of the first nonwoven sheet member 4. The disposable nonwoven implement 1 also comprise five sleeves 8.

Moisture Retention Methodology

As described above, the implements of the present invention can be “substantially dry”. As used herein, “substantially dry” means that the implements of the present invention exhibit a Moisture Retention of less than about 0.95 gms, less than about 0.75 gms, less than about 0.5 gms, less than about 0.25 gms, less than about 0.15 gms, and less than about 0.1 gms. The Moisture Retention is indicative of the dry feel that users perceive upon touching the implements of the present invention as opposed to the feel of “wet” implements.

In order to determine the Moisture Retention of the present implements and other disposable nonwoven implement products, the following equipment and materials are needed.

| | |
|---|---|
| Bounty White Paper Towel | Procter & Gamble SKU 37000 63037 |
| | Basis Weight = 42.14 gsm |
| Balance | Accurate to 0.0 g |
| Lexan | 0.5″ thickness |
| | large enough to cover samples |
| | completely and weighs 1000 g |
| Weight | A 2000 g weight or combination to |
| | equal 2000 g |

Next, weigh two paper towels separately and record each weight. Place one paper towel on flat surface (e.g., lab bench). Place the sample implement on top of that towel. Place the other paper towel on top of sample implement. Next, place the Lexan and then the 2000 g weight(s) on top of the sandwiched sample implement. Wait 1 minute. After the minute, remove weight(s) and Lexan. Weigh the top and bottom paper towel and record the weight.

Calculate the Moisture Retention by subtracting the initial paper towel weight from the final weight (after 1 minute) for both the top and bottom paper towels. Add the weight differences obtained for the top and bottom paper towels. Assuming multiple implements are tested, average the total weight differences to obtain the Moisture Retention.

As described above, the implements of the present invention can be “substantially dry”, “moist”, or “wet” prior to use. The implement can feel dry to the touch and still contain high water content. The Moisture Retention is indicative of the dry feel that users perceive upon touching the implements of the present invention as opposed to the feel of “wet” implements. Thus, implements of the present invention that feel dry to the touch can have a dry feel relatively independent of the amount of fluid they contain. Implements of the present invention which have a dry feel will exhibit a Moisture Retention of less than about 0.95 gms, less than about 0.75 gms, less than about 0.5 gms, less than about 0.25 gms, less than about 0.15 gms, and less than about 0.1 gms.

As described above, the implements of the present invention can be “wet” prior to use. The implement can feel wet to the touch and contain high fluid content. The weight percent of fluid in the “wet” implement is based on the dry weight of the implement. Thus, the “wet” implements of the present invention will generally comprise from about greater than 40% by weight of fluid, from 40% to about 95% by weight of the dry implement of fluid, and from about 50% to about 80% by weight of the dry implement of fluid.

The implement can feel relatively dry to the touch and still contain high fluid content. Thus, the “moist” implements of the present invention will generally comprise from about 20% to about 40% by weight of the dry implement of fluid.

### Multiple Article Embodiment

The present invention also covers kits comprising a plurality of the disposable nonwoven implement that has a composition associated with the implement. In addition, a kit for a companion animal implement comprising: (a) a composition; and (b) a disposable nonwoven implement said implement comprising: (a) a first and second nonwoven sheet members, said first and second nonwoven members being secured to each other along at least a portion of a periphery of said nonwoven sheet members to form an interior volume between said nonwoven sheet members and an opening to receive a user's hand.

### Methods of Manufacture

The implements of the present invention can be manufactured by separately or simultaneously adding onto the surface of said implement and, onto or impregnating into said implement, before or after it has undergone processing, a cleansing, conditioning and, or a treatment composition. By “separately” is meant that the cleansing, conditioning and treatment compositions can be added sequentially, in any order without first being combined together. By “simultaneously” is meant that the cleansing, conditioning, and treatment compositions can be added with or without first being combined together.

The cleansing, conditioning, and/or the treatment composition can be embedded onto or impregnated into the disposable nonwoven implement using any means known to those skilled in the art. These components can be applied using various spraying, soaking, coating or dipping techniques. Excess cleansing, conditioning and/or conditioning component can be removed (e.g., by a nipping process). The resulting implement can remain as wet or can be further processed to be moist or substantially dry using conventional methods known in the art.

### Methods of Using Articles

The present invention also relates to a method of cleansing and, or treating or conditioning the skin, hair, paws, ears, nails, or other keratin-containing tissues of the companion animal with a disposable nonwoven implement of the present invention. These methods comprise the steps associating the composition with the nonwoven disposable implement; and contacting said skin, hair and other keratinous surfaces with a disposable nonwoven implement; and optionally rinsing said skin, hair and other keratinous surfaces of said companion animal with water The implements of the present invention can already contain fluid prior to use, or not require any fluid in order to use the implement. Lather is generated from the implement by mechanically agitating and/or deforming the implement either prior to or during contact of the implement companion animal.

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention. All exemplified amounts are concentrations by weight of the compositions, unless otherwise specified.

### Implement Example 1

### Substantially Dry Disposable Nonwoven Glove

A glove can be constructed by combining four nonwoven sheet members together. The first nonwoven sheet member can be comprised of bicomponent polyethylene and polypropylene fiber. The third and fourth nonwoven sheet members can be comprised of a batting layer and the second nonwoven sheet member can be comprised of another bicomponent material. The first nonwoven sheet member can be coated with an composition and dried and then add a treatment agent. The bicomponent materials are processed through a selective mechanical deformation process prior to combination of the four nonwoven sheet members. The four nonwoven sheet members are then bonded together using an ultrasonic bonder in a shape described in the Figures above and then rotary cut into individual gloves.

### Implement Example 2

### Wet Disposable Nonwoven Glove

A mitt can be constructed by combining four nonwoven sheet members together. The first nonwoven sheet member can be comprised of hydroentangled polypropylene and rayon. The second nonwoven sheet member can be comprised of a needle punched rayon and polyester fibers and third nonwoven sheet member can be comprised of a batting material and the fourth nonwoven sheet members can be comprised of another bicomponent material. The bicomponent material is processed through a selective mechanical deformation process prior to combination of the four nonwoven sheet members. The four nonwoven sheet members are then bonded together using an ultrasonic bonder in a shape described in the Figures above and then rotary cut into individual units. After ultrasonic bonding but prior to die cutting into individual units the implements are associated with 4 grams any one of the composition disclosed in Composition Examples 1-25.

### Implement Example 3

### Wet Disposable Nonwoven Mitt Comprised of Four Nonwoven Sheet Members, Printed Raised Elements and Closure

A mitt can be constructed by combining four nonwoven sheet members together. The first nonwoven sheet member can be a thermally bonded composite of four layers, the outer two layers can be thermally bonded carded nonowoven and the inner two layers can be cellulose paper. The third nonwoven sheet member can be an air-laid nonwoven made from cellulose and bicomponent re-enforcing fibers. An array of large and small raised elements made from thermoplastic based resin can be printed onto the surface of the third nonwoven sheet member facing that of the first nonwoven sheet member. A fourth nonwoven sheet member can be hydroformed and apertured polyethylene film. A second nonwoven sheet member can be polyethylene coated vacuum apertured elastic film. A Velcro® closure strip is added to the four nonwoven sheet members such that a free end of the Velcro® strip can be fastened to the first nonwoven sheet member. The four nonwoven sheet members and closure strip are then bonded together using a heat sealer in a shape described in the Figures above and rotary cut into individual units. After heat seal bonding but prior to die cutting into individual units, the implements are associated with 50 grams any one of the composition disclosed in Composition Examples 1-25.

### Implement Example 4

### Wet Disposable Nonwoven Glove Comprised of Four Nonwoven Sheet Members, Printed Raised Elements and Closure

A glove can be constructed by combining four nonwoven sheet members together. The first nonwoven sheet member can be a thermally bonded composite of four layers, the outer two layers can be thermally bonded carded nonowoven and the inner two layers can be cellulose paper. The third nonwoven sheet member can be an air-laid nonwoven made from cellulose and bicomponent re-enforcing fibers. An array of large and small raised elements made from thermoplastic based resin can be printed onto the surface of the third nonwoven sheet member facing that of the first nonwoven sheet member. A fourth nonwoven sheet member can be hydroformed and apertured polyethylene film. A second nonwoven sheet member can be polyethylene coated vacuum apertured elastic film. A Velcro® closure strip is added to the four nonwoven sheet members such that a free end of the Velcro® strip can be fastened to the first nonwoven sheet member. The four nonwoven sheet members and closure strip are then bonded together using a heat sealer in a shape described in the Figures above and rotary cut into individual units. After heat seal bonding but prior to die cutting into individual units, the implements are associated with 50 grams of any one of the composition disclosed in Composition Examples 1-25.

### Implement Example 5

### Wet Disposable Nonwoven Glove Comprised of Three Nonwoven Sheet Members with Printed Raised Elements

A glove can be constructed by combining three nonwoven sheet members together. The first nonwoven sheet member can be an air-laid nonwoven made from cellulose and bicomponent re-enforcing fibers. Large and small raised elements made from thermoplastic based resin can be printed onto the outer face of the first nonwoven sheet member in an array. A third nonwoven sheet member is a hydroformed and apertured polyethylene film. A second nonwoven sheet member can be polyethylene coated vacuum apertured elastic film. The three nonwoven sheet members are then bonded together using a heat sealer in a shape described in the Figures above and rotary cut into individual units. After heat seal bonding but prior to die cutting into individual units, the implements are associated with 50 grams any one of the composition disclosed in Composition Examples 1-25.

### Implement Example 6

### Wet Disposable Nonwoven Glove with Discrete Raised Elements and Composite Nonwoven

A glove can be constructed by combining four nonwoven sheet members together. The first nonwoven sheet member can be a thermally bonded composite of four layers, the outer two layers can be thermally bonded carded nonowoven and the inner two layers can be cellulose paper. The third nonwoven sheet member can be an air-laid nonwoven made from cellulose and bicomponent re-enforcing fibers. Discrete prefabricated polypropylene solid spheres can be placed in a single layer between the first and third nonwoven sheet members and fastened with adhesive to the nonwoven sheet members. A fourth nonwoven sheet member is a hydroformed and apertured polyethylene film. A second nonwoven sheet member can be polyethylene coated vacuum apertured elastic film. The four nonwoven sheet members are then bonded together using a heat sealer in a shape described in the Figures above and rotary cut into individual units. After heat seal bonding but prior to die cutting into individual units, the implements are associated with 50 grams any one of the composition disclosed in Composition Examples 1-25.

### Implement Example 7

### Wet Disposable Nonwoven Glove with Pre-formed Raised Elements and Composite Nonwoven

A glove can be constructed by combining four nonwoven sheet members together. The first nonwoven sheet member can be a thermally bonded composite of four layers, the outer two layers can be thermally bonded carded nonowoven and the inner two layers can be cellulose paper. The third nonwoven sheet member can be a carded nonwoven made with polyester and polyester co-polymer fibers. Before incorporation, raised elements can be formed on the third nonwoven sheet member by processing it between two heated, intermeshing, and counter rotating nipped rolls. One of the rolls can have the positive or male pattern of raised elements which intermesh with its negative or female pattern in the mating roll. As the carded polyester/co-polyester nonwoven is passed through the nipped rolls, the pattern of raised elements is formed in the nonwoven. The pressure of the nip and the heat from rolls melts the co-polyester fibers which, upon cooling, re-solidify into the matrix of polyester fibers and give the formed raised elements structural permanence. The fourth nonwoven sheet member can be an air-laid nonwoven made from cellulose and bicomponent re-enforcing fibers. A fourth nonwoven sheet member is a hydroformed and apertured polyethylene film. A second nonwoven sheet member can be an elastic film. The four nonwoven sheet members are then bonded together using a heat sealer in a shape described in the Figures above and rotary cut into individual units. After heat seal bonding but prior to die cutting into individual units, the implements are associated with 50 grams any one of the composition disclosed in Composition Examples 1-25.

### Implement Example 8

### Wet Disposable Nonwoven Mitten Comprised of Four Nonwoven Sheet Members, Printed Raised Elements and Closure

A mitten can be constructed by combining four nonwoven sheet members together. The first nonwoven sheet member can be a thermally bonded composite of four layers, the outer two layers can be thermally bonded carded nonowoven and the inner two layers can be cellulose paper. The third nonwoven sheet member can be an air-laid nonwoven made from cellulose and bicomponent re-enforcing fibers. An array of large and small raised elements made from thermoplastic based resin can be printed onto the surface of the third nonwoven sheet member facing that of the first nonwoven sheet member. A fourth nonwoven sheet member can be hydroformed and apertured polyethylene film. A second nonwoven sheet member can be polyethylene coated vacuum apertured elastic film. A Velcro® closure strip is added to the four nonwoven sheet members such that a free end of the Velcro® strip can be fastened to the first nonwoven sheet member. The four nonwoven sheet members and closure strip are then bonded together using a heat sealer in a shape described in the Figures above and rotary cut into individual units. After heat seal bonding but prior to die cutting into individual units, the implements are associated with 50 grams any one of the composition disclosed in Composition Examples 1-25.

This previously described implement Examples 1-8 can be associated with any one of the following compositions described in Composition Examples 1-25:

### Composition Examples 1-6

| | Example | Example | Example | Example | Example | Example |
|---|---|---|---|---|---|---|
| Raw Material | 1 wt. % | 2 wt. % | 3 wt. % | 4 wt. % | 5 wt. % | 6 wt. % |
| Polyoxyethylene (20) | 0.347 | 0.347 | 0.347 | 0.347 | 0.347 | 0.347 |
| Isohexadecyl Ether | | | | | | |
| Polyacrylic Acid | 0.1 | x | 0.1 | 0.10 | 0.10 | 0.1 |
| Propylene Glycol | 0.15 | 0.15 | 0.15 | 0.15 | 0.15 | 0.15 |
| Fragrance | 0.015 | 0.015 | 0.015 | 0.015 | 0.015 | 0.015 |
| DMDM Hydantoin | 0.2 | 0.2 | 0.2 | 0.2 | 0.2 | 0.2 |
| Sodium Benzoate | 0.2 | 0.2 | 0.2 | 0.2 | 0.2 | 0.2 |
| Poloxamer 184 | 1.0 | 1.0 | 1.0 | 1.0 | 1.0 | x |
| Poloxyethylene 4 Sorbitan | 0.5 | 0.5 | 0.5 | 0.5 | 0.5 | 1.0 |
| Monolaurate | | | | | | |
| Divinyldimethicone/Dimethicone | 0.3 | x | x | x | x | x |
| Copolymer | | | | | | |
| Amodimethicone | x | 0.3 | x | x | x | x |
| Dimethicone | x | x | 0.3 | x | x | x |
| Dimethiconol | x | x | x | x | x | x |
| Silicone Quaternium-16 | x | x | x | 0.3 | x | x |
| Alkylmethyl Siloxane Copolyol | x | x | x | x | 0.3 | x |
| Polydimethylsiloxane | 0.1 | 0.1 | 0.1 | 0.1 | 0.1 | 0.1 |
| Aloe Vera Gel | 0.2 | 0.2 | 0.2 | 0.2 | 0.2 | 0.2 |
| beta Cyclodextrin | 0.1 | 0.1 | 0.1 | 0.1 | 0.1 | 0.1 |
| Triethanolamine | 0.1 | 0.1 | 0.1 | 0.1 | 0.1 | 0.1 |
| Polysorbate 20 | x | x | x | x | x | x |
| Oleth-10 | x | x | x | x | x | x |
| Disodium Laureth Sulfosuccinate | x | x | x | x | x | 0.5 |
| 4-chloro-3,5-dimethylphenol | x | x | x | x | x | x |
| Laureth-23 | x | x | x | x | x | x |
| Ajidew NL-50 | x | x | x | x | x | x |
| Hydroxypropyl beta | x | x | x | x | x | x |
| Cyclodextrin | | | | | | |
| Sodium Alkyl Glyceryl | x | x | x | x | x | x |
| Sulfonate | | | | | | |
| Sodium Methyl-2 Sulfo C12–C18 | x | x | x | x | x | x |
| Ester | | | | | | |
| Salicylic Acid | x | x | x | x | x | x |
| Citric Acid | x | x | x | x | x | x |
| Polyalkyleneoxide | x | x | x | x | x | x |
| Polydimethylsiloxane | | | | | | |
| Potassium Sorbate | x | x | x | x | x | x |
| Poloxamer 333 | x | x | x | x | x | x |
| PEG-6 Caprylic/Capric | x | x | x | x | x | x |
| Glycerides | | | | | | |
| PPG-12 PEG-50 Lanolin | x | x | x | x | x | x |
| Water | qs to | qs to | qs to | qs to | qs to | qs to |
| | 100% | 100% | 100% | 100% | 100% | 100% |

### Composition Examples 7-12

| | Example | Example | Example | Example | Example | Example |
|---|---|---|---|---|---|---|
| Raw Material | 7 wt. % | 8 wt. % | 9 wt. % | 10 wt. % | 11 wt. % | 12 wt. % |
| Polyoxyethylene (20) | 0.347 | 0.347 | 0.347 | 0.347 | 0.347 | 0.347 |
| Isohexadecyl Ether | | | | | | |
| Polyacrylic Acid | 0.1 | 0.1 | 0.1 | x | 0.1 | x |
| Propylene Glycol | 0.15 | 0.15 | 0.1 | 0.15 | 0.15 | 0.15 |
| Fragrance | 0.015 | 0.015 | 0.1 | 0.075 | 0.015 | 0.015 |
| DMDM Hydantoin | 0.2 | 0.2 | 0.2 | x | 0.2 | 0.2 |
| Sodium Benzoate | 0.2 | 0.2 | x | 0.25 | 0.2 | 0.2 |
| Poloxamer 184 | 1.0 | 1.0 | x | x | 1.0 | x |
| Poloxyethylene 4 Sorbitan | x | x | x | x | 0.5 | x |
| Monolaurate | | | | | | |
| Divinyldimethicone/Dimethicone | x | 0.3 | x | x | x | 0.5 |
| Copolymer | | | | | | |
| Amodimethicone | x | x | x | x | x | x |
| Dimethicone | 0.3 | x | x | x | x | x |
| Dimethiconol | x | x | x | x | 0.3 | x |
| Silicone Quaternium-16 | x | x | x | x | x | x |
| Alkylmethyl Siloxane Copolyol | x | x | x | x | x | x |
| Polydimethylsiloxane | 0.1 | x | x | x | 0.1 | x |
| Aloe Vera Gel | 0.2 | x | 0.2 | 0.2 | 0.2 | 0.2 |
| beta Cyclodextrin | 0.1 | 0.05 | 0.3 | 0.05 | 0.1 | 0.1 |
| Triethanolamine | 0.1 | 0.2 | 0.2 | 0.2 | 0.1 | 0.1 |
| Polysorbate 20 | x | x | x | x | x | 1.0 |
| Oleth-10 | x | x | x | x | x | 0.5 |
| Disodium Laureth Sulfosuccinate | x | x | x | x | x | x |
| 4-chloro-3,5-dimethylphenol | x | x | 0.1 | 0.1 | x | x |
| Laureth-23 | x | 0.2500 | x | 0.25 | x | x |
| Ajidew NL-50 | x | x | 0.2 | 0.4 | x | x |
| Hydroxypropyl beta Cyclodextrin | x | x | 3.0 | 3.0 | x | x |
| Sodium Alkyl Glyceryl Sulfonate | x | x | 0.86 | 0.172 | x | x |
| Sodium Methyl-2 Sulfo C12–C18 | x | x | 0.25 | 0.272 | x | x |
| Ester | | | | | | |
| Salicylic Acid | x | x | x | 0.2000 | x | x |
| Citric Acid | x | x | x | 0.1000 | x | x |
| Polyalkyleneoxide | x | x | 0.25 | x | x | x |
| Polydimethylsiloxane | | | | | | |
| Potassium Sorbate | x | x | 0.2 | x | x | x |
| Poloxamer 333 | 0.5 | 0.5 | x | x | x | x |
| PEG-6 Caprylic/Capric | x | 0.5 | x | x | x | x |
| Glycerides | | | | | | |
| PPG-12 PEG-50 Lanolin | x | 0.5 | x | x | x | x |
| Water | qs to | qs to | qs to | qs to | qs to | qs to |
| | 100% | 100% | 100% | 100% | 100% | 100% |

### Composition Examples 13-18

| | Example | Example | Example | Example | Example | Example |
|---|---|---|---|---|---|---|
| Raw Material | 13 wt. % | 14 wt % | 15 wt. % | 16 wt. % | 17 wt. % | 18 wt % |
| Polyoxyethylene (20) | 0.347 | 0.347 | 0.347 | 0.347 | 0.347 | 0.347 |
| Isohexadecyl Ether | | | | | | |
| Polyacrylic Acid | 0.1 | 0.1 | 0.10 | 0.1 | 0.1 | 0.1 |
| Propylene Glycol | 0.15 | 0.15 | 0.15 | 0.15 | 0.15 | 0.15 |
| Fragrance | 0.015 | 0.015 | 0.015 | 0.015 | 0.015 | 0.015 |
| DMDM Hydantoin | 0.2 | 0.2 | 0.2 | 0.2 | 0.20 | 0.2 |
| Sodium Benzoate | 0.2 | 0.2 | 0.2 | 0.2 | 0.20 | 0.2 |
| Poloxamer 184 | 15.0 | 25.0 | 40.0 | 50.0 | 60.0 | 1.0 |
| Poloxyethylene 4 Sorbitan | 5.0 | 15.0 | 20.0 | 25.0 | 30.0 | 0.5 |
| Monolaurate | | | | | | |
| Divinyldimethicone/Dimethicone | 0.3 | 0.3 | 0.3 | 0.3 | 0.3 | 5.0 |
| Copolymer | | | | | | |
| Amodimethicone | x | x | x | x | x | x |
| Dimethicone | x | x | x | x | x | x |
| Dimethiconol | x | x | x | x | x | x |
| Silicone Quaternium-16 | x | x | x | x | x | x |
| Alkylmethyl Siloxane Copolyol | x | x | x | x | x | x |
| Polydimethylsiloxane | 2.0 | 2.0 | 2.0 | 2.0 | 2.0 | 0.1 |
| Aloe Vera Gel | 0.2 | 0.2 | 0.2 | 0.2 | 0.2 | 0.2 |
| beta Cyclodextrin | 0.1 | 0.1 | 0.1 | 0.1 | 0.1 | 0.1 |
| Triethanolamine | 0.1 | 0.1 | 0.1 | 0.1 | 0.1 | 0.1 |
| Polysorbate 20 | x | x | x | x | x | x |
| Oleth-10 | x | x | x | x | x | x |
| Disodium Laureth Sulfosuccinate | x | x | x | x | x | x |
| 4-chloro-3,5-dimethylphenol | x | x | x | x | x | x |
| Laureth-23 | x | x | x | x | x | x |
| Ajidew NL-50 | x | x | x | x | x | x |
| Hydroxypropyl beta | x | x | x | x | x | x |
| Cyclodextrin | | | | | | |
| Sodium Alkyl Glyceryl | x | x | x | x | x | x |
| Sulfonate | | | | | | |
| Sodium Methyl-2 Sulfo C12–C18 | x | x | x | x | x | x |
| Ester | | | | | | |
| Salicylic Acid | x | x | x | x | x | x |
| Citric Acid | x | x | x | x | x | x |
| Polyalkyleneoxide | x | x | x | x | x | x |
| Polydimethylsiloxane | | | | | | |
| Potassium Sorbate | x | x | x | x | x | x |
| Poloxamer 333 | x | x | x | x | x | x |
| PEG-6 Caprylic/Capric | x | x | x | x | x | x |
| Glycerides | | | | | | |
| PPG-12 PEG-50 Lanolin | x | x | x | x | x | x |
| Water | qs to | qs to | qs to | qs to | qs to | qs to |
| | 100% | 100% | 100% | 100% | 100% | 100% |

### Composition Examples 19-24

| | Example | Example | Example | Example | Example | Example |
|---|---|---|---|---|---|---|
| Raw Material | 19 wt. % | 20 wt. % | 21 wt. % | 22 wt % | 23 wt. % | 24 wt. % |
| Polyoxyethylene (20) | 0.347 | 0.347 | 0.347 | 0.347 | 0.347 | 0.347 |
| Isohexadecyl Ether | | | | | | |
| Polyacrylic Acid | 0.1 | 0.1 | 0.1 | 0.1 | 0.1 | 0.1 |
| Propylene Glycol | 0.15 | 0.15 | 0.15 | 0.15 | 0.15 | 0.15 |
| Fragrance | 0.015 | 0.015 | 0.015 | 0.015 | 0.015 | 0.015 |
| DMDM Hydantoin | 0.2 | 0.2 | 0.2 | 0.2 | 0.2 | 0.2 |
| Sodium Benzoate | 0.2 | 0.2 | 0.2 | 0.2 | 0.2 | 0.2 |
| Poloxamer 184 | 1.0 | 1.0 | 1.0 | 1.0 | 1.0 | 1.0 |
| Poloxyethylene 4 Sorbitan | 0.5 | 0.5 | 0.5 | 0.5 | 0.5 | 0.5 |
| Monolaurate | | | | | | |
| Divinyldimethicone/Dimethicone | 20.0 | 50.0 | 75.0 | 0.3 | 0.3 | 0.3 |
| Copolymer | | | | | | |
| Amodimethicone | x | x | x | x | x | X |
| Dimethicone | x | x | x | x | x | X |
| Dimethiconol | x | x | x | x | x | X |
| Silicone Quaternium-16 | x | x | x | x | x | X |
| Alkylmethyl Siloxane Copolyol | x | x | x | x | x | X |
| Polydimethylsiloxane | 0.1 | 0.1 | 0.1 | 0.1 | 0.1 | 0.1 |
| Aloe Vera Gel | 0.2 | 0.2 | 0.2 | 5.0 | 20.0 | 50.0 |
| beta Cyclodextrin | 0.1 | 0.1 | 0.1 | 0.1 | 0.1 | 0.1 |
| Triethanolamine | 0.1 | 0.1 | 0.1 | 0.1 | 0.1 | 0.1 |
| Polysorbate 20 | X | x | x | x | x | X |
| Oleth-10 | X | x | x | x | x | X |
| Disodium Laureth Sulfosuccinate | X | x | x | x | x | X |
| 4-chloro-3,5-dimethylphenol | X | x | x | x | x | X |
| Laureth-23 | X | x | x | x | x | X |
| Ajidew NL-50 | X | x | x | x | x | x |
| Hydroxypropyl beta | X | x | x | x | x | x |
| Cyclodextrin | | | | | | |
| Sodium Alkyl Glyceryl | X | x | x | x | x | x |
| Sulfonate | | | | | | |
| Sodium Methyl-2 Sulfo C12–C18 | X | x | x | x | x | x |
| Ester | | | | | | |
| Salicylic Acid | X | x | x | x | x | x |
| Citric Acid | X | x | x | x | x | x |
| Polyalkyleneoxide | X | x | x | x | x | x |
| Polydimethylsiloxane | | | | | | |
| Potassium Sorbate | X | x | x | x | x | x |
| Poloxamer 333 | X | x | x | x | x | x |
| PEG-6 Caprylic/Capric | X | x | x | x | x | x |
| Glycerides | | | | | | |
| PPG-12 PEG-50 Lanolin | X | x | x | x | x | x |
| Water | qs to | qs to | qs to | qs to | qs to | qs to |
| | 100% | 100% | 100% | 100% | 100% | 100% |

### Composition Example 25

| | Example |
|---|---|
| Raw Material | 25 wt. % |
| Polyoxyethylene (20) Isohexadecyl | 0.347 |
| Ether | |
| Polyacrylic Acid | 0.1 |
| Propylene Glycol | 0.15 |
| Fragrance | 0.015 |
| DMDM Hydantoin | 0.2 |
| Sodium Benzoate | 0.2 |
| Poloxamer 184 | 1.0 |
| Poloxyethylene 4 Sorbitan | 0.5 |
| Monolaurate | |
| Divinyldimethicone/Dimethicone | 0.3 |
| Copolymer | |
| Amodimethicone | X |
| Dimethicone | X |
| Dimethiconol | X |
| Silicone Quaternium-16 | X |
| Alkylmethyl Siloxane Copolyol | X |
| Polydimethylsiloxane | 0.1 |
| Aloe Vera Gel | 75.0 |
| beta Cyclodextrin | 0.1 |
| Triethanolamine | 0.1 |
| Polysorbate 20 | X |
| Oleth-10 | X |
| Disodium Laureth Sulfosuccinate | X |
| 4-chloro-3,5-dimethylphenol | X |
| Laureth-23 | X |
| Ajidew NL-50 | X |
| Hydroxypropyl beta Cyclodextrin | X |
| Sodium Alkyl Glyceryl Sulfonate | X |
| Sodium Methyl-2 Sulfo C12–C18 | X |
| Ester | |
| Salicylic Acid | X |
| Citric Acid | X |
| Polyalkyleneoxide | X |
| Polydimethylsiloxane | |
| Potassium Sorbate | X |
| Poloxamer 333 | X |
| PEG-6 Caprylic/Capric Glycerides | X |
| PPG-12 PEG-50 Lanolin | X |
| Water | qs to 100% |

### Examples 1-25

Composition Examples 1-25 may be prepared using conventional formulation and mixing techniques.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A disposable nonwoven implement, said implement comprising:
(a) a first and second nonwoven sheet members, said first and second nonwoven members being secured to each other along at least a portion of a periphery of said nonwoven sheet members to form an interior volume between said nonwoven sheet members and an opening to receive a user's hand; and
(b) a composition associated with at least one of said first and second nonwoven sheet members.

2. The disposable nonwoven implement of claim 1, wherein said first and second nonwoven sheet members comprise fibers.

3. The disposable nonwoven implement of claim 2, wherein said fibers are selected from the group consisting of natural fibers, synthetic fibers, and combinations thereof.

4. The disposable nonwoven implement of claim 3, wherein said fibers are selected from the group consisting of monocomponent fibers, multicomponent fibers, multiconstituent fibers, capillary channel fibers, hollow fibers, shaped or lobed fibers, and combinations thereof.

5. The disposable nonwoven implement of claim 1, wherein said nonwoven sheet members are prepared by meltblowing, spunbonding, air-entanglement, hydroentanglement, thermal bonding, selective mechanical deformation and combination thereof.

6. The disposable nonwoven implement of claim 1, wherein said implement is selected from the group consisting of a mitt, a mitten, a glove, and combinations thereof.

7. The disposable nonwoven implement of claim 6, wherein said implement comprises at least one sleeve for insertably receiving at least one finger.

8. The disposable nonwoven implement of claim 1, wherein said implement further comprises a wrist portion.

9. The disposable nonwoven implement of claim 8, wherein said wrist portion comprises a closure means.

10. The disposable nonwoven implement of claim 1, wherein an exterior surface of said first nonwoven sheet member and an exterior surface of said second nonwoven sheet member have different textures.

11. The disposable nonwoven implement of claim 1, wherein at least one of the nonwoven sheet members comprise a raised element.

12. The disposable nonwoven implement of claim 1, wherein at least one of said exterior surfaces of said first and second nonwoven sheet members comprises a material for collecting an animal hair.

13. The disposable nonwoven implement of claim 12, wherein said material is a bristle.

14. The disposable nonwoven implement of claim 1, wherein said implement comprises less than about 20% by weight of the implement of a fluid.

15. The disposable nonwoven implement of claim 1, wherein said implement comprise from about 20% to about 40% by weight of the implement of a fluid.

16. The disposable nonwoven implement of claim 1, wherein said implement comprises from about 40% to about 95% by weight of the implement of a fluid.

17. The disposable nonwoven implement of claim 1, wherein said composition comprises shampoos, treatment agents, conditioning agents, cleansing agents, or mixtures thereof.

18. The disposable nonwoven implement of claim 17, wherein said treatment agents are selected from the group consisting of vitamins, cyclodextrins, zeolites, peptides, terpene alcohols, desquamation actives, anti-atrophy actives, anti-oxidants, flavanoids, anti-inflammatory agents, topical anesthetics, chelators, antimicrobial actives, anti-fungal actives, soothing actives, healing actives, moisturizing actives, flea actives, tick actives, other insect actives, and mixtures thereof.

19. The disposable nonwoven implement of claim 17, wherein said conditioning agents are selected from the group consisting of silicone oils, silicone polymers, functional silicone polymers, fatty acids, esters of fatty acids, fatty alcohols, ethoxylates, polyol polyesters, glycerine, glycerin mono-esters, glycerin polyesters, epidermal and sebaceous hydrocarbons, lanolin, straight and branched hydrocarbons, vegetable oil, vegetable oil adduct, hydrogenated vegetable oils, nonionic polymers, natural waxes, petrolatum, petrolatum derivatives, synthetic waxes, polyolefinic glycols, polyolefinic monoester, polyolefinic polyesters, cholesterols, cholesterol esters, and mixtures thereof.

20. The disposable nonwoven implement of claim 17, wherein said cleansing agents comprise a surfactant, wherein said surfactant is selected from the group consisting of anionic surfactant selected from the group consisting of sarcosinates, sulfates, ethoxylated sulfate, sulfonates, glyceryl sulfonates, isethionates, phosphates, taurates, lactylates, glutamates, soaps, sulfosuccinates, ethoxylated sulfosuccinates, and mixtures thereof; nonionic surfactant selected from the group consisting of alkyl glucosides, polyglucosides, polyhydroxy fatty acid amides, alkoxylated fatty acid esters, sugar esters, ethoxylated esters, glycerol esters, ethoxylates, propoxylates, PEG/PPG copolymers, glycerides, sorbitans, and mixtures; amphoteric surfactant selected from the group consisting of amine oxides, betaines, sultaines, hydroxysultaines, alkyliminoacetates, iminodialkanoates, aminoalkanoates, and mixtures thereof.

21. A disposable nonwoven implement, said implement comprising:
(a) a first and second nonwoven sheet members, said first and second nonwoven members being secured to each other along at least a portion of a periphery of said nonwoven sheet members to form an interior volume between said nonwoven sheet members and an opening to receive a user's hand;
(b) a composition associated with at least one of said first and second nonwoven sheet members; and
wherein said implement is a glove.

22. The disposable nonwoven implement of claim 21, wherein said first and second nonwoven sheet members comprise fibers.

23. The disposable nonwoven implement of claim 22, wherein said fibers are selected from the group consisting of natural fibers, synthetic fibers, and combinations thereof.

24. The disposable nonwoven implement of claim 22, wherein said fibers are selected from the group consisting of monocomponent fibers, multicomponent fibers, multiconstituent fibers, capillary channel fibers, hollow fibers, shaped or lobed fibers, and combinations thereof.

25. The disposable nonwoven implement of claim 21, wherein said nonwoven sheet members are prepared by meltblowing, spunbonding, air-entanglement, hydroentanglement, thermal bonding, selective mechanical deformation and combination thereof.

26. The disposable nonwoven implement of claim 21, wherein said glove comprises at least one sleeve for insertably receiving at least one finger.

27. The disposable nonwoven implement of claim 21, wherein said glove further comprises a wrist portion.

28. The disposable nonwoven implement of claim 27, wherein said wrist portion comprises a closure means.

29. The disposable nonwoven implement of claim 21, wherein an exterior surface of said first nonwoven sheet member and an exterior surface of said second nonwoven sheet member have different textures.

30. The disposable nonwoven implement of claim 21, wherein at least one of the nonwoven sheet members comprises a raised element.

31. The disposable nonwoven implement of claim 21, wherein at least one of said exterior surfaces of said first and second nonwoven sheet members comprises a material for collecting an animal hair.

32. The disposable nonwoven implement of claim 31, wherein said material is a bristle.

33. The disposable nonwoven implement of claim 21, wherein said glove comprises less than about 20% by weight of the implement of a fluid.

34. The disposable nonwoven implement of claim 21, wherein said glove comprise from about 20% to about 40% by weight of the implement of a fluid.

35. The disposable nonwoven implement of claim 21, wherein said glove comprises from about 40% to about 95% by weight of the implement of a fluid.

36. The disposable nonwoven implement of claim 21, wherein said composition comprises shampoos, treatment agents, conditioning agents, cleansing agents, or mixtures thereof.

37. A disposable nonwoven implement, said implement comprising:
(a) a first and second nonwoven sheet members; wherein at least one of said members is a multi-layer nonwoven sheet member; wherein said first and second nonwoven members are secured to each other along at least a portion of a periphery of said nonwoven sheet members to form an interior volume between said nonwoven sheet members and an opening to receive said user's hand; and
(b) a composition associated with at least one of said first and second nonwoven sheet members.

38. The disposable nonwoven implement of claim 37, wherein said multi-layered nonwoven sheet member comprises at least one batting layer.

39. The disposable nonwoven implement of claim 38, wherein said batting layer is selected from the group consisting of fibrous nonwovens, sponges, foams, reticulated foams, polymeric nets, scrims, vacuum-formed laminates, formed films, formed film composite material, and combinations thereof.

40. The disposable nonwoven implement of claim 37, wherein said composition comprises treatment agents, conditioning agents, cleansing agents, or mixtures thereof.

41. The disposable nonwoven implement of claim 37, wherein said first and second nonwoven sheet members comprises fibers selected from the group consisting of natural fibers, synthetic fibers, and combinations thereof.

42. The disposable nonwoven implement of claim 37, wherein said implement is selected from the group consisting of a mitt, a mitten, a glove, and combinations thereof.

43. The disposable nonwoven implement of claim 37, wherein said implement comprises at least one sleeve for insertably receiving at least one finger.

44. The disposable nonwoven implement of claim 37, wherein said implement further comprises a wrist portion.

45. The disposable nonwoven implement of claim 44, wherein said, wrist portion comprises a closure means.

46. The disposable nonwoven implement of claim 37, wherein an exterior surface of said first nonwoven sheet member and an exterior surface of said second nonwoven sheet member have different textures.

47. The disposable nonwoven implement of claim 37, wherein at least one of the nonwoven sheet members comprise a raised element.

48. The disposable nonwoven implement of claim 37, wherein at least one of said exterior surfaces of said first and second nonwoven sheet members comprises a material for collecting animal hair.

49. A disposable nonwoven implement, said implement comprising:
(a) a first and second nonwoven sheet members, said first and second nonwoven members being secured to each other along at least a portion of a periphery of said nonwoven sheet members to form an interior volume between said nonwoven sheet members and an opening to receive a user's hand;
(b) a composition associated with at least one of said first and second nonwoven sheet members; and
wherein said implement further comprises a third nonwoven sheet member.

50. The disposable implement of claim 49, wherein at least one of the nonwoven sheet members comprise a raised element.

51. The disposable implement of claim 50, wherein said raised element is located on the exterior surface of said first nonwoven sheet member.

52. The disposable implement of claim 50, wherein said raised element is located between said first nonwoven sheet member and said third nonwoven sheet member.

53. The disposable implement of claim 49, further comprising a fourth nonwoven sheet member.

54. A kit for a companion animal implement comprising:
(a) a composition; and
(b) a disposable nonwoven implement according to claim 1.

55. A kit for a companion animal implement comprising:
(a) a composition; and
(b) a disposable nonwoven implement according to claim 49.

56. A method of cleansing conditioning, or therapeutically treating skin, hair and other keratinous surfaces of a companion animal comprising the steps of:
a. associating the composition with the nonwoven disposable implement according to claim 1; and
b. contacting said skin, hair and other keratinous surfaces with a disposable nonwoven implement; and
c. optionally rinsing said skin, hair and other keratinous surfaces of said companion animal with water.

57. A method of cleansing, conditioning or therapeutically treating the skin, hair and other keratinous surfaces of a companion animal comprising the steps of:
(a) contacting said skin, hair and other keratinous surfaces with the nonwoven disposable implement of claim 21; and
(b) optionally rinsing said skin, hair and other keratin-containing surfaces of said companion animal with water.
